(19) United States
(12) Patent Application Publication
(10) Pub. No.: US 2023/0249137 A1
(43) Pub. Date: Aug. 10, 2023

(54) FILTRATION APPARATUS CONTAINING ALKYLATED GRAPHENE OXIDE MEMBRANE

(71) Applicant: Via Separations, Inc., Watertown, MA (US)

(72) Inventors: Stephen Hale FRAYNE, Watertown, MA (US); Lymaris ORTIZ RIVERA, Cambridge, MA (US)

(21) Appl. No.: 18/116,762

(22) Filed: Mar. 2, 2023

Related U.S. Application Data
(63) Continuation of application No. PCT/US2022/078051, filed on Oct. 13, 2022.
(60) Provisional application No. 63/255,723, filed on Oct. 14, 2021.

(51) Int. Cl. B01D 71/02; C01B 32/198; C01B 32/194; B01J 20/20; B01J 20/26; B01J 20/28; B01J 20/30; B01J 20/32; D21C 11/00; B01D 69/10; B01D 69/12; B01D 69/02; B01D 67/00

(52) U.S. Cl. CPC B01D 71/0211; C01B 32/198; C01B 32/194; B01J 20/205; B01J 20/262; B01J 20/28035; B01J 20/28007; B01J 20/3085; B01J 20/3212; B01J 20/324; D21C 11/0042; B01D 71/024; B01D 69/107; B01D 69/1213; B01D 69/02; B01D 69/1216; B01D 67/0046; B01D 67/0076; B01D 67/0044; C01B 2204/04; B01D 2325/06; B01D 2323/081; B01D 2323/219; B01D 2323/36

(57) ABSTRACT

The present disclosure relates to an alkylated graphene oxide membrane comprising a plurality of graphene oxide layers, each graphene oxide layer including at least one graphene oxide sheet covalently coupled to a chemical spacer, the chemical spacer being of Formula I:

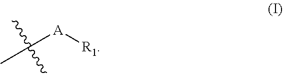

The present disclosure also relates to a filtration apparatus comprising an alkylated graphene oxide membrane disposed on a support substrate.

### RELATED APPLICATIONS

This application claims priority to and the benefit of U.S. Provisional Patent Application No. 63/255,723, filed on Oct. 14, 2021, the disclosure of which is hereby incorporated by reference in its entirety.

### GOVERNMENT SUPPORT

This invention was made with U.S. government support under Grant No. DE-AR0001043 awarded by the Department of Energy. The U.S. government has certain rights in the invention.

### TECHNICAL FIELD

The present disclosure generally relates to graphene oxide membranes and their use in separation processes.

### BACKGROUND

Membranes can be used to separate a mixture by passing some components (filtrate or permeate) and retaining others preferentially with a balance of the mixture (rejects) according to any of a variety of properties of the membrane and/or of the components of the material being filtered. For example, membranes can be configured to separate rejects from a filtrate based on size exclusion (i.e., a physical barrier such as pores that are smaller than the excluded particles). Other examples include membranes that are configured to separate rejects from a filtrate based on chemical, electrochemical, and/or physical binding with one or more components of the material being filtered.

Graphene oxide membranes are a relatively new type of membrane. While graphene oxide membranes hold a lot of promises, there remains a challenge to chemically engineer a graphene oxide membrane to achieve the desired filtration characteristics such as high conductivity rejection.

### SUMMARY

One aspect of the present disclosure relates to a filtration apparatus, comprising: a support substrate; and an alkylated graphene oxide membrane disposed on the support substrate, the alkylated graphene oxide membrane comprising a plurality of graphene oxide layers, each graphene oxide layer including at least one graphene oxide sheet covalently coupled to a chemical spacer, the chemical spacer being of Formula I:

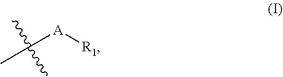

wherein:

### A is O, NH, or S; and

R₁ is optionally substituted C₁-C₅ alkyl; and [symbol] indicates a point of connection to a carbon atom on the alkylated graphene oxide sheet.

In some embodiments, A is O.

In some embodiments, R₁ is optionally substituted C2-C5 alkyl.

In some embodiments, R₁ is selected from —CH₂CH₃, —(CH₂)₂CH₃, —CH(CH₃)₂, —(CH₂)₃CH₃, —CH(CH₃)₂CH₂CH₃, —CH₂CH(CH₃)₂, or —C(CH₃)₃, —(CH₂)₄CH₃, —C(CH₃)₂CH₂CH₃, —CH₂C(CH₃)₃, —(CH₂)₂CH(CH₃)₂, —CH(CH₃)(CH₂)₂CH₃, —CH(CH₂CH₃)₂, —CH(CH₃)CH(CH₃)₂, and —CH₂CH(CH₃)CH₂CH₃.

In some embodiments, R₁ is —(CH₂)₂CH₃

In some embodiments, the filtration apparatus has a conductivity rejection rate of at least 50% for synthetic weak black liquor.

In some embodiments, the filtration apparatus is further characterized by a flux of greater than 5.0E-04 gallons per square foot per day per psi (GFD/psi) for synthetic weak black liquor.

In some embodiments, each of the graphene oxide sheets is not covalently crosslinked to the adjacent graphene oxide sheet.

In some embodiments, the support substrate comprises one or more material selected from polypropylene (PP), polystyrene, polyethylene, polyethylene oxide, polyethersulfone (PES), polytetrafluoroethylene (PTFE), polyvinylidene fluoride, polymethylmethacrylate, polydimethylsiloxane, polyester, polyolefin, cellulose, cellulose acetate, cellulose nitrate, polyacrylonitrile, glass fiber, quartz, alumina, silver, polycarbonate, nylon, Kevlar or other aramid, and polyether ether ketone.

In some embodiments, the graphene oxide membrane has a thickness of about 25 nm to about 5 μm.

In some embodiments, the graphene oxide membrane has about 100 to about 600 graphene oxide layers.

In some embodiments, the conductivity rejection rate is measured at room temperature.

In some embodiments, the filtration apparatus has a conductivity rejection of at least 60% for synthetic weak black liquor, or at least 40% for weak black liquor.

Another aspect of the present disclosure relates to a method of preparing an alkylated graphene oxide membrane, comprising: (i) ultrasonicating a first mixture of a graphene oxide material and a base in water, thereby exfoliating graphene oxide layers from the graphene oxide material; (ii) adding a C₁-C₅ alkyl halide to the first mixture to form a second mixture; (iii) heating the second mixture for a period of time at greater than 60° C., thereby forming an alkylated graphene oxide; (iv) removing water from the second mixture to obtain the alkylated graphene oxide; (v) dispersing the alkylated graphene oxide in a solvent, thereby forming an alkylated graphene oxide dispersion; and (vi) casting the alkylated graphene oxide dispersion onto a solid support, thereby forming the alkylated graphene oxide membrane.

In some embodiments, the base comprises NaOH, KOH, or a combination thereof.

In some embodiments, the graphene oxide material to water in the first mixture are present at a weight ratio of greater than about 1 to 900.

In some embodiments, the first mixture further comprises a phase transfer catalyst.

In some embodiments, the phase transfer catalyst is selected from tetraoctylammonium halide, benzyltriethylammonium halide, methyltricaprylammonium halide, methyltributylammonium halide, and methyltrioctylammonium halide, hexadecyltributylphosphonium halide, and tetra-n-butylammonium halide.

In some embodiments, the second mixture is heated for a period of time of about 4 hours to about 24 hours.

In some embodiments, the second mixture is heated at a temperature of about 63° C. to about 67° C.

In some embodiments, the method further comprises washing the alkylated graphene oxide obtained from step iv) with chloroform or methanol prior to dispersion.

In some embodiments, the solvent in step v) is an aromatic solvent.

In some embodiments, the aromatic solvent is selected from benzene, benzonitrile, benzyl alcohol, chlorobenzene, dibenzyl ether, 1,2-dichlorobenzene, 1,2-difluorobenzene, hexafluorobenzene, mesitylene, nitrobenzene, pyridine, tetralin, toluene, 1,2,4-trichlorobenzene, trifluorotoluene, and xylenes.

In some embodiments, the aromatic solvent is selected from benzene, chlorobenzene, 1,2-dichlorobenzene, 1,2-difluorobenzene, toluene, 1,2,4-trichlorobenzene, trifluorotoluene, and xylenes.

In some embodiments, the aromatic solvent is selected from benzene, chlorobenzene, toluene, and xylenes.

In some embodiments, dispersing the alkylated graphene oxide in a solvent in step v) comprises ultrasonication or high shear mixing

In some embodiments, the C₁-C₅ alkyl halide is C₂-C₅ alkyl halide.

In some embodiments, the C₂-C₅ alkyl halide is C₂-C₅ alkyl chloride, C₂-C₅ alkyl-iodide, or C₁-C₅ alkyl bromide.

Another aspect of the present disclosure relates to a graphene oxide membrane produced by the preparation method described herein.

Another aspect of the present disclosure relates to a method of processing black liquor, the method comprising flowing black liquor through the filtration apparatus described herein, wherein the black liquor comprises one or more selected from lignin, sodium sulfate, sodium carbonate, sodium hydrosulfide, sodium thiosulfate, and sodium hydroxide.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1A is a graph showing the flux data for propylated graphene oxide (Propyl-GO) measured with synthetic weak black liquor (sWBL). PG1 is a propionamide functionalized graphene oxide.

FIG. 1B is a graph showing the refractive index (RI) rejection data for Propyl-GO measured with sWBL. Refractive index was measured using a refractometer, and rejection was calculated using the formula: (1-RI of permeate/RI of feed)*100. The RI of the feed and concentrate are the same.

FIG. 1C is a graph showing the conductivity rejection data for Propyl-GO measured with sWBL.

FIG. 2 is a graph showing the rejection rate for graphene oxide membranes prepared with different graphene oxide:water ratio during the exfoliation step.

FIG. 3 is an image illustrating the stability of Propyl-GO in different solvents. Propyl-GO was added to 4 mL scintillation vials (8 mg/mL). The vials were sonicated at 40 kHz for 2 hours and left undisturbed for 48 hours at room temperature.

FIG. 4A is a set of histograms that quantify the results of the modified ASTM D3359 tape test. The inset in each histogram is a photograph showing the white area left behind when a portion of the graphene oxide membrane is peeled off by the tape. Each histogram shows the distribution of gray values for each image with the x-axis representing possible gray values (0-255) and the y-axis representing the number of pixels found at each gray value. Grayscale mode values closer to zero correspond to darker images. Conversely, grayscale mode values closer to 255 correspond to lighter images.

FIG. 4B is a set of images showing the Propyl-GOs membranes in weak black liquor environment. The Propyl-GOs membranes were placed in 25 mL scintillation vials, and submerged in pH 13 weak black liquor permeate. The vials were then sonicated at 40 kHz for one hour.

FIG. 5 shows FTIR spectra of Propyl-GO from recorded after synthesis reaction at: i) at 65° C. for 6 hours (spectrum A); ii) at 60° C. for 6 hours (spectrum B); and iii) at 60° C. for 24 hours (spectrum C).

FIG. 6A is a graph showing the filtration data for Propyl-GO with a softwood kraft pulp sourced from a mill in Georgia, and the test was run at 800 psig and 75° C.

FIG. 6B is a graph showing the filtration data for Propyl-GO with a hardwood kraft pulp sourced from a mill in Wisconsin, and the test was run at 1000 psig and 75° C.

FIG. 6C is a graph showing the filtration data for Propyl-GO with a eucalyptus kraft pulp, and the test was run at 800 psig and 75° C.

FIG. 7 is a set of images showing the surface morphologies for Hexyl-GO and Propyl-GO.

FIG. 8 is a graph showing the filtration data for Propyl-GO with softwood kraft pulp sourced from a mill in Georgia. The test was conducted at 800 psig and 75° C., and demonstrates the filtration performance over three passes. Briefly, the permeate collected during the “1^{st} pass” is used as the process feed in the “2^{nd} pass,” and the permeate from the “2^{nd} pass” is used as the process feed for the “3^{rd} pass”. In between the passes, a cleaning step is conducted at 150 psig and 40° C. for 1 hour. PG1, which is propionamide functionalized graphene oxide, served as control.

FIG. 9 is graph showing the filtration data for Propyl-GO with both hardwood and softwood kraft pulp sourced from a mill in Wisconsin. The test was conducted at 1000 psig with a one hour clean between switching feeds.

FIG. 10A is a graph showing the 1^{st} pass filtration data for RAD-1 (a propionamide functionalized graphene oxide that has been heated for 24 hours).

FIG. 10B is a graph comparing 2^{nd} pass filtration data of RAD-1 and propyl-GO.

FIG. 10C is a graph comparing the 3^{rd} pass filtration data of RAD-1 and propyl-GO.

FIG. 11 is a graph showing the crossflow filtration data with the 1^{st} pass permeate collected from a softwood kraft pulp sourced from a mill in Georgia. The test was conducted at 800 psi and 75° C. Solvent studies showed that DMF and toluene are good candidates for the material solubilization. Filtration data showed that DMF has worse filtration performance than toluene.

### DETAILED DESCRIPTION

Graphite is a crystalline form of carbon with its atoms arranged in a hexagonal structure layered in a series of planes. Due to its abundance on earth, graphite is very cheap and is commonly used in pencils and lubricants. Graphene is a single, one atomic layer of carbon atoms (i.e., one of the layers of graphite) with several exceptional electrical, mechanical, optical, and electrochemical properties, earning it the nickname “the wonder material.” To name just a few, it is highly transparent, extremely light and flexible yet robust, and an excellent electrical and thermal conductor. Such extraordinary properties render graphene and related thinned graphite materials (e.g., few layer graphene) as promising candidates for a diverse set of applications. For example, graphene can be used in coatings to prevent steel and aluminum from oxidizing, and to filter salt, heavy metals, and oil from water.

Graphene oxide is an oxidized form of graphene having oxygen-containing pendant functional groups (e.g., epoxide, carboxylic acid, or hydroxyl) that exist in the form of single atom thick sheets. By oxidizing the graphene in graphite, graphene oxide sheets can be produced. For example, the graphene oxide sheets can be prepared from graphite using a modified Hummers method. Flake graphite is oxidized in a mixture of KMnO₄, H₂SO₄, and/or NaNO₃, then the resulting pasty graphene oxide was diluted and washed through cycles of filtration, centrifugation, and resuspension. The washed graphene oxide suspension is subsequently ultrasonicated to exfoliate graphene oxide particles into graphene oxide sheets and centrifuged at high speed to remove unexfoliated graphite residues. The resulting yellowish/light brown solution is the final graphene oxide sheet suspension. This color indicated that the carbon lattice structure is distorted by the added oxygenated functional groups. The produced graphene oxide sheets are hydrophilic and can stay suspended in water for months without a sign of aggregation or deposition.

### Alkylated Graphene Oxide Membrane

By conjugating C₁-C₅ alkyl to graphene oxide sheets, graphene oxide membranes can be chemically engineered to exhibit enhanced conductivity rejection and improved adhesion.

Accordingly, in one aspect, the present disclosure provides an alkylated graphene oxide sheet covalently coupled to a chemical spacer, wherein: the chemical spacer being of Formula I:

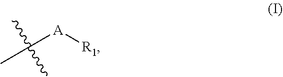

wherein:

### A is O, NH, or S;

R₁ is optionally substituted C₁-C₅ alkyl; and [symbol] indicates a point of connection to a carbon atom on the graphene oxide sheet.

In some embodiments, A is O. In some embodiments, A is NH. In some embodiments, A is S.

In some embodiments, R₁ is optionally substituted C₂-C₅ alkyl. In some embodiments, R₁ is optionally substituted C₂-C₄ alkyl. In some embodiments, R₁ is optionally substituted C₃-C₅ alkyl. In some embodiments, R₁ is optionally substituted C₃-C₄ alkyl.

In some embodiments, R₁ is optionally substituted C₁ alkyl. In some embodiments, R₁ is optionally substituted C₂ alkyl. In some embodiments, R₁ is optionally substituted C3 alkyl. In some embodiments, R₁ is optionally substituted C₄ alkyl. In some embodiments, R₁ is optionally substituted C₅ alkyl.

In some embodiments, R₁ is unsubstituted C₁ alkyl. In some embodiments, R₁ is unsubstituted C₂ alkyl. In some embodiments, R₁ is unsubstituted C₃ alkyl. In some embodiments, R₁ is unsubstituted C₄ alkyl. In some embodiments, R₁ is unsubstituted C₅ alkyl.

In some embodiments, R₁ is unsubstituted C₂-C₅ alkyl, e.g., —CH₂CH₃, —(CH₂)₂CH₃, —CH(CH₃)₂, —(CH₂)₃CH₃, —CH(CH₃)₂CH₂CH₃, —CH₂CH(CH₃)₂, —C(CH₃)₃, —(CH₂)₄CH₃, —C(CH₃)₂CH₂CH₃, —CH₂C(CH₃)₃, —(CH₂)₂CH(CH₃)₂, —CH(CH₃)(CH₂)₂CH₃, —CH(CH₂CH₃)₂, —CH(CH₃)CH(CH₃)₂, or —CH₂CH(CH₃)CH₂CH₃.

In another aspect, the present disclosure provides alkylated graphene oxide membranes comprising a plurality of graphene oxide layers, each graphene oxide layer including at least one alkylated graphene oxide sheet as discloses herein. In some embodiments, each of the graphene oxide sheets is not covalently crosslinked to the adjacent graphene oxide sheet.

The alkylated graphene oxide membrane exhibits improved adhesion. The adhesion property of graphene oxide membranes can be determined using a modified ASTM D3359 tape test.

The modified ASTM D3359 tape test includes the following steps: (1) cut a piece of ASTM D3359 Cross Hatch Adhesion Test Tape and fold a corner so it is easy for removal; (2) place the piece of tape in the coating area (away from edges), make sure that the tape is in contact with the surface; and avoid creating any air gaps; and (3) wait 90 seconds and remove the tape in one quick motion. As compared to the standard ASTM D3359 tape test, the modified tape test does not include an incision step or a step of inspecting the incisions.

The adhesion property can be qualitatively determined by visually inspecting the amount of ‘white area’ left behind when a portion of the graphene oxide membrane is peeled off by the tape. The more the amount of the white area is, the less adhesive the graphene oxide membrane is. The less the amount of the white area is, the more adhesive the graphene oxide membrane is.

The adhesion property can be quantitatively determined by quantifying the amount of ‘white area’ left behind when a portion of the graphene oxide membrane is peeled off by the tape. In some embodiments, the white area can be quantified using an image processing software (e.g., ImageJ). The image processing software can be used to create histograms of the gray values and then calculate grayscale mode values of the white area. Only the white areas resulting from the removal of the tape are used as bounds for calculating the grayscale mode values. A grayscale mode value of the white area with a mean intensity of less than 70 is considered good adhesion, and a grayscale mode value of the white area with a mean intensity of greater than 160 in considered poor adhesion.

In some embodiments, the alkylated graphene oxide membrane can include greater than about 100 layers, greater than about 125 layers, greater than about 150 layers, greater than about 175 layers, greater than about 200 layers, greater than about 225 layers, or greater than about 250 layers of graphene oxide sheet. In some embodiments, the graphene oxide membrane 100 can include less than about 600 layers, less than about 550 layers, less than about 500 layers, less than about 450 layers, less than about 400 layers, less than about 350 layers, or less than about 300 layers of alkylated graphene oxide sheets.

Combinations of the above-referenced ranges for the number of layers are also contemplated (e.g., greater than about 100 layers to less than about 600 layers, or greater than about 300 layers to less than about 600 layers).

In some embodiments, the alkylated graphene oxide membrane can include about 100 to about 600 layers of graphene oxide sheets, e.g., 200-500 layers, 200-400 layers, 200-300 layers, 200-250 layers, 300-600 layers, 300-500 layers, or 300-400 layers.

In some embodiments, the alkylated graphene oxide membrane can have a thickness greater than or equal to about 25 nm, greater than or equal to about 50 nm, greater than or equal to about 100 nm, greater than or equal to about 150 nm, greater than or equal to about 200 nm, greater than or equal to about 300 nm, greater than or equal to about 400 nm, greater than or equal to about 500 nm, greater man or equal to about 750 nm, greater than or equal to about 1 micron, or greater than or equal to about 2 microns. In some embodiments, the thickness of the graphene oxide membrane may be less man or equal to about 5 microns, less than or equal to about 1 micron, less than or equal to about 500 nm, less than or equal to about 250 nm, or less than or equal to about 100 nm.

Combinations of the above-referenced ranges for the thickness of the alkylated graphene oxide membrane are also contemplated (e.g., greater than or equal to about 25 nm to less than or equal to about 5 microns, greater than or equal to about 0.15 microns to less than or equal to about 0.5 microns).

In some embodiments, the alkylated graphene oxide membrane can have a thickness of about 25 nm, about 50 nm, about 100 nm, about 150 nm, about 200 nm, about 250 nm, about 300 nm, about 350 nm, about 400 nm, about 450 nm, about 500 nm, about 550 nm, about 600 nm, about 0.65 nm, about 700 nm, about 750 nm, about 800 nm, about 850 nm, about 900 nm, about 950 nm, about 1.0 micron, about 1.5 microns, or about 2 microns.

In some embodiments, the molecular weight cutoff for the alkylated graphene oxide membrane is about 100 Da. In some embodiments, the molecular weight cutoff for the alkylated graphene oxide membrane is about 150 Da. In some embodiments, the molecular weight cutoff for the alkylated graphene oxide membrane is about 200 Da. In some embodiments, the molecular weight cutoff for the alkylated graphene oxide membrane is about 250 Da. In some embodiments, the molecular weight cutoff for the alkylated graphene oxide membrane is about 300 Da. In some embodiments, the molecular weight cutoff for the alkylated graphene oxide membrane is about 350 Da.

In some embodiments, the color of the graphene oxide membrane can be used to assess the membrane's stability under elevated temperatures and/or basic pH levels. The color of the graphene oxide membrane can be characterized by recording images of the graphene oxide membrane, and calculating the grayscale mode value with the aid of using image processing software. The range of grayscale mode value that an image can assume is zero to 255, with values closer to zero corresponding to darker images, and values closer to 255 corresponding to lighter images.

In some embodiments, the alkylated graphene oxide membrane can display a grayscale mode value of less than about 180, less than about 160, less than about 140, less than about 120, less than about 100, less than about 80, less than about 60, or less than about 40, inclusive of all values and ranges therebetween, where the image of the graphene oxide membrane is collected in a lightbox with dimensions 9.4×9.1×8.7″ and two rows of 20 white LEDs on the top front and rear edge of the lightbox. In some embodiments, the graphene oxide membrane can display a grayscale mode value of at least about 20, at least about 25, at least about 30, at least about 45, at least about 60, at least about 75, inclusive of all values and ranges therebetween, where the image of the graphene oxide membrane is collected in a lightbox with dimensions 9.4×9.1×8.7″ and two rows of 20 white LEDs on the top front and rear edge of the lightbox.

Combinations of the above-referenced ranges for the grayscale mode value are also possible (e.g., at least about 20 and less than about 180, or at least 90 and less than about 120).

Other ways to quantify the color of the alkylated graphene oxide membrane can also be used. For example, distribution shape, center of a fit, and/or standard deviation can be used.

The lighting level to obtain an image of the alkylated graphene oxide membrane can have an effect on the grayscale mode value. For comparison purposes, the same or substantially the same lighting level should be used to obtain two or more images of the same membrane at different time points or different membranes.

### Filtration Apparatus

In a further aspect, the present disclosure provides filtration apparatuses that include a support substrate and an alkylated graphene oxide membrane as disclosed in the present disclosure. The alkylated graphene oxide membrane can be disposed on the support substrate.

In some embodiments, the filtration apparatus further comprises a housing. The housing can enclose the support substrate and the alkylated graphene oxide membrane.

In some embodiments, the filtration apparatus has a conductivity rejection of at least 50% for synthetic weak black liquor. In some embodiments, the filtration apparatus has a conductivity rejection of greater than 55% for synthetic weak black liquor. In some embodiments, the filtration apparatus has a conductivity rejection of greater than 60% for synthetic weak black liquor. In some embodiments, the filtration apparatus has a conductivity rejection of greater than 65% for synthetic weak black liquor. In some embodiments, the filtration apparatus has a conductivity rejection of greater than 70% for synthetic weak black liquor. In some embodiments, the filtration apparatus has a conductivity rejection of greater than 75% for synthetic weak black liquor. In some embodiments, the filtration apparatus has a conductivity rejection of greater than 80% for synthetic weak black liquor. In some embodiments, the filtration apparatus has a conductivity rejection rate for synthetic weak black liquor of greater than 85%. In some embodiments, the filtration apparatus has a conductivity rejection of greater than 90% for synthetic weak black liquor. In some embodiments, the filtration apparatus has a conductivity rejection of greater than 95% for synthetic weak black liquor.

In some embodiments, the filtration apparatus can have a flux of greater than about 2.5×10⁻⁴ GFD/psi, greater than about 5.0×10⁻⁴ GFD/psi, greater than about 7.5×10⁻⁴ GFD/psi, greater than about 1.0×10⁻³ GFD/psi, greater than about 1.25×10⁻³ GFD/psi, greater than about 1.5×10⁻³ GFD/psi, greater than about 1.75×10⁻³GFD/psi, greater than about 2.0×10⁻³ GFD/psi, greater than about 2.25×10⁻³ GFD/psi, greater than about 2.5×10⁻³ GFD/psi, greater than about 5.0×10⁻³ GFD/psi, greater than about 10.0×10⁻³ GFD/psi, greater than about 15.0×10⁻³ GFD/psi, or greater than about 20.0×10⁻³ GFD/psi, measured with synthetic weak black liquor at room temperature.

In some embodiments, the filtration apparatus can have a flux of less than about 40.0×10⁻³ GFD/psi, less than about 35.0×10⁻³ GFD/psi, less than about 30.0×10⁻³ GFD/psi, less than about 20.0×10⁻³ GFD/psi, less than about 15.0×10⁻³ GFD/psi, less than about 10.0×10⁻³ GFD/psi, measured with synthetic weak black liquor at room temperature.

Combinations of the above-referenced ranges for the flux are also contemplated (e.g., greater than about 2.5×10⁻⁴ GFD/psi and less than about 40.0×10⁻³ GFD/psi, or greater than about 5.0×10⁻³ GFD/psi and less than about 30.0×10⁻³ GFD/psi).

In some embodiments, the flux is measured at 50 psi to 1000 psi, such as about 50 psi, about 75 psi, about 100 psi, about 125 psi, about 150 psi, about 175 psi, about 200 psi, about 225 psi, about 250 psi, about 275 psi, about 300 psi, about 325 psi, about 350 psi, about 375 psi, about 400 psi, about 425 psi, about 450 psi, about 475 psi, about 500 psi, about 525 psi, about 550 psi, about 575 psi, about 600 psi, about 625 psi, about 650 psi, about 675 psi, about 700 psi, about 725 psi, about 750 psi, about 775 psi, about 800 psi, about 825 psi, about 850 psi, about 875 psi, about 900 psi, about 925 psi, about 950 psi, about 975 psi, or about 1000 psi.

In some embodiments, the filtration apparatus can have a flux of 2.5×10⁻⁴ to 3.75×10⁻² GFP/psi, 2.5×10⁻⁴ to 2.5×10⁻² GFP/psi, 2.5×10−3 to 2.5×10⁻² GFP/psi, or 1.25×10⁻² to 2.5×10⁻² GFP/psi, measured with synthetic weak black liquor at room temperature.

In some embodiments, the alkylated graphene oxide membrane can have a lactose rejection rate of greater than 50%, greater than 60%, greater than 65%, greater than 70%, greater than 75%, greater than 80%, greater than 85%, greater than 90%, greater than 95%, greater than 98%, or greater than 99%, with a 1 wt % lactose solution. The lactose rejection rate can be measured at room temperature.

In some embodiments, the alkylated graphene oxide membrane can have a lactose rejection rate of 50% to 99.5% with a 1 wt % lactose solution. In some embodiments, the graphene oxide membrane can have a lactose rejection rate of 60% to 99.5% with a 1 wt % lactose solution. In some embodiments, the graphene oxide membrane can have a lactose rejection rate of 70% to 99.5% with a 1 wt % lactose solution. In some embodiments, the graphene oxide membrane can have a lactose rejection rate of 80% to 99.5% with a 1 wt % lactose solution. In some embodiments, the graphene oxide membrane can have a lactose rejection rate of 90% to 99.5% with a 1 wt % lactose solution. In some embodiments, the graphene oxide membrane can have a lactose rejection rate of 95% to 99.5% with a 1 wt % lactose solution.

In some embodiments, the alkylated graphene oxide membrane can have a MgSO₄ rejection rate of greater than 30%, greater than 40%, greater than 50%, greater than 60%, greater than 65%, greater than 70%, greater than 75%, greater than 80%, greater than 85%, greater than 90%, greater than 95%, greater than 98%, or greater than 99%, with a 0.1 wt % MgSO₄ solution. The MgSO₄ rejection rate can be measured at room temperature.

In some embodiments, the alkylated graphene oxide membrane can have a MgSO₄ rejection rate of 30% to 99.5% with a 0.1 wt % MgSO₄ solution. In some embodiments, the graphene oxide membrane can have a MgSO₄ rejection rate of 40% to 99.5% with a 0.1 wt % MgSO₄ solution. In some embodiments, the graphene oxide membrane can have a MgSO₄ rejection rate of 50% to 99.5% with a 0.1 wt % MgSO₄ solution. In some embodiments, the graphene oxide membrane can have a MgSO₄ rejection rate of 60% to 99.5% with a 0.1 wt % MgSO₄ solution. In some embodiments, the graphene oxide membrane can have a MgSO₄ rejection rate of 70% to 99.5% with a 0.1 wt % MgSO₄ solution. In some embodiments, the graphene oxide membrane can have a MgSO₄ rejection rate of 80% to 99.5% with a 0.1 wt % MgSO₄ solution. In some embodiments, the graphene oxide membrane can have a MgSO₄ rejection rate of 90% to 99.5% with a 0.1 wt % MgSO₄ solution. In some embodiments, the graphene oxide membrane can have a MgSO₄ rejection rate of 95% to 99.5% with a 0.1 wt % MgSO₄ solution.

The procedure for characterizing rejection rate and permeability of the alkylated graphene oxide membrane is shown below: (1) cut a 22 in² area sheet from the alkylated graphene oxide membrane using a steel rule die or laser cuter; (2) load the sheet with the alkylated graphene oxide side up, feed spacer, and permeate carrier into a SEPA or CF₀₄₂ tangential flow test cell; (3) add 2 to 3 L of synthetic weak black liquor or weak black liquor; (4) close the feed chamber and pressurize it up to 1000 psi. Under this procedure, the experiment is run continuously with permeate recycling back into the feed tank and samples are collected periodically to ensure that the performance measurement was steady.

The support substrate can include a non-woven fiber or polymer. In some embodiments, the support substrate can include polypropylene (PP), polystyrene, polyethylene, polyethylene oxide, polyethersulfone (PES), polytetrafluoroethylene (PTFE), polyvinylidene fluoride, polymethylmethacrylate, polydimethylsiloxane, polyester, polyolefin, cellulose, cellulose acetate, cellulose nitrate, polyacrylonitrile, glass fiber, quartz, alumina, silver, polycarbonate, nylon, Kevlar or other aramid, polyether ether ketone, or a combination thereof.

In some embodiments, the support substrate is a microporous substrate. The support substrate can have an average pore size of 0.1 μm to 10 μm, e.g., 0.1 μm to 8 μm, 0.1 μm to 5 μm, 0.2 μm to 5 μm, 0.2 μm to 2 μm, or 0.2 μm to 1 μm. In some embodiments, the support substrate can have an average pore size less than 1 μm, such as about 0.2 μm, about 0.3 μm, about 0.4 μm, about 0.45 μm, about 0.5 μm, about 0.55 μm, about 0.6 μm, about 0.65 μm, about 0.7 μm, or about 0.75 μm.

In some embodiments, the support substrate can have a thickness of less than about 750 μm, less than about 700 μm, less than about 650 μm, less than about 550 μm, less than about 500 μm, less than about 450 μm, or less than about 400 μm. In some embodiments, the support substrate can have a thickness of greater than about 200 μm, greater than about 220 μm, or greater than about 240 μm, inclusive of all values and ranges therebetween.

Combinations of the above referenced ranges for the thickness of the support substrate are also contemplated (e.g., a thickness of greater than about 200 μm and less than about 750 μm, greater than about 240 μm and less than about 500 μm).

In some embodiments, the alkylated graphene oxide membrane and the support substrate can have a combined thickness of about 100 microns, about 150 microns, about 200 microns, about 250 microns, about 300 microns, about 350 microns, about 400 microns, about 450 microns, about 500 microns, about 550 microns, about 600 microns, about 650 microns, about 700 microns, about 750 microns, about 800 microns, about 850 microns, about 900 microns, about 950 microns, or about 1 mm.

It was discovered that the roughness of the support substrate can have an impact on the flux of the alkylated graphene oxide membrane. Specifically, a smooth support substrate can improve the flux and/or rejection rate of the graphene oxide membrane as compared to a rough support substrate. Accordingly, in some embodiments, the support substrate can be smooth. For example, the support substrate has a root mean squared surface roughness of less than about 3 μm, less than about 2.5 μm, less than about 2 μm, less than about 1.5 μm, or less than about 1 μm. In some embodiments, the support substrate of the graphene oxide membrane 100 can have a root mean squared surface roughness of greater than about 1 μm, greater than about 1.2 μm, greater than about 1.4 μm, greater than about 1.5 μm. In some embodiments, the surface roughness is measured by a Dektak 6M Contact Profilometer.

Combinations of the above-referenced ranges for the root mean squared surface roughness are also contemplated (e.g., greater than about 1 μm and less than 2.5 μm, or greater than 1.4 μm and less than about 3 μm). In some embodiments, the support substrate has a root mean squared surface roughness of about 3 μm, about 2.5 μm, about 2 μm, about 1.5 μm, or about 1 μm.

In some embodiments, the filtration apparatus includes about 0.1 mg to 6 mg of the alkylated graphene oxide membrane per 5000 mm². In some embodiments, the filtration apparatus includes about 0.1 mg to 5 mg, about 0.1 mg to 4 mg, about 0.1 mg to 3 mg, about 0.5 mg to 5 mg, about 0.5 mg to 4 mg, about 0.5 mg to 3 mg, about 1 mg to 4 mg, or about 1 mg to 3 mg of the alkylated graphene oxide membrane per 5000 mm². For example, the filtration apparatus can include about 1 mg, about 1.5 mg, about 2 mg, about 2.5 mg, or about 3 mg of the alkylated graphene oxide membrane per 5000 mm².

In some embodiments, the support substrate can comprise a hollow polymer tube. The hollow polymer tube can have a surface area greater than or equal to about 100 cm².

In some embodiments, the alkylated graphene oxide membrane can comprise a plurality of flat polymer sheets combined to form a spiral filtration module. For example, in some embodiments, a spiral filtration module can comprise a plurality of flat polymer sheets stacked atop one another, and the plurality of stacked flat polymer sheets may be rolled around a core tube. In some embodiments, prior to being rolled around the core tube, adjacent flat polymer sheets may be separated by a sheet of feed channel spacer to form a leaf, and each leaf may be separated by a sheet of permeate spacer. When the flat polymer sheets, the one or more feed channel spacers, and the one or more permeate spacers are rolled around the core tube, each permeate spacer may form a permeate channel.

To improve the membrane's durability under high-pressure operations, e.g., about 500 psi to 1600 psi or greater, in some embodiments, the support substrate can have a Young's modulus of less than about 1.2 GPa, less than about 1.1 GPa, less than about 1.0 GPa, less than about 0.9 GPa, less than about 0.8 GPa, less than about 0.7 GPa, less than about 0.6 GPa, or less than about 0.5 GPa, inclusive of all values and ranges therebetween. In some embodiments, the support substrate can have a Young's modulus of greater than about 0.5 GPa, greater than about 0.65 GPa, greater than about 0.75 GPa, greater than about 0.85 GPa, greater than about 0.95 GPa, greater than about 1.0 GPa, greater than about 1.1 GPa, or greater than about 1.3 GPa, inclusive of all values and ranges therebetween.

Combinations of the above referenced ranges for the Young's modulus of the support substrate are also contemplated (e.g., a Young's modulus of greater than about 0.5 GPa and less than about 1.3 GPa, or greater than about 0.6 GPa and less than about 0.8 GPa). In some embodiments, the high-pressure operation is about 900 psi, about 1000 psi, about 1100 psi, about 1200 psi, about 1300 psi, about 1400 psi, about 1500 psi, or about 1600 psi.

In some embodiments, the support substrate suitable for high-pressure durability can comprise PES, PTFE, PP, PAN, polyolefin, nylon, or a combination thereof.

The support substrate can have one layer, two layers, three layers, or more. In some embodiments, the support substrate can include two or more layers. For example, the support substrate can include a first layer and a second layer, the first layer is disposed on the second layer, wherein the first layer and the second layer have different average pore sizes. In some embodiments, the alkylated graphene oxide membrane is disposed on the first layer, and the first layer has a smaller average pore size than the second layer. In some embodiments, the support substrate can comprise a first layer in contact with the alkylated graphene oxide membrane, and a second layer disposed on the first layer, the second layer configured to provide further mechanical support. The first layer can comprise the same material as the second layer. For example, the first layer can comprise PES, and the second layer can comprise PES. The first layer can comprise a different material from the second layer.

In some embodiments, the support substrate can comprise a first layer in contact with the alkylated graphene oxide membrane, a second layer disposed on the first layer, and a third layer disposed on the second layer. For example, the first layer can comprise PTFE; the second layer can comprise PP; and the third layer can comprise PES.

In some embodiments, the support substrate can comprise a first layer in contact with the alkylated graphene oxide membrane, a second layer disposed on the first layer, a third layer disposed on the second layer, and a fourth layer disposed on the third layer. For example, the first layer can comprise PTFE; the second layer can comprise PP; the third layer can comprise PTFE; and the fourth layer can comprise PP.

### Methods of Manufacture of the Graphene Oxide Membrane and the Filtration Apparatus

In yet another aspect, the present disclosure provides methods of preparing an alkylated graphene oxide membrane, comprising:
i) stirring and/or agitating a first mixture of a graphene oxide material and a base in water, thereby exfoliating graphene oxide layers from the graphene oxide material;
ii) adding a C₁-C₅ alkyl halide to the first mixture to form a second mixture;
iii) heating the second mixture for a period of time at greater than 60° C., thereby forming an alkylated graphene oxide;
iv) removing water from the second mixture to obtain the alkylated graphene oxide;
v) dispersing the alkylated graphene oxide in a solvent, thereby forming an alkylated graphene oxide dispersion; and
vi) casting the alkylated graphene oxide dispersion onto a solid support, thereby forming the alkylated graphene oxide membrane.

In some embodiments, the base is an inorganic base. In some embodiments, the base comprises NaOH, KOH, or a combination thereof.

In some stirring and/or agitating may be conducted with any suitable device configured to mix components of a mixture. For example, in some embodiments stirring and/or agitating can be done with an ultrasonicator. In such embodiments, the ultrasonicator is configured to operate at a frequency of at least 20 kHz, at least 25 kHz, at least 30 kHz, at least 35 kHz, at least 40 kHz, at least 45 kHz, at least 50 kHz, at least 55 kHz, or at least 60 kHz, inclusive of all values and ranges therebetween. In some embodiments, the ultrasonicator is configured to operate at a frequency of no more than 60 kHz, no more than 56 kHz, no more than 52 kHz, no more than 48 kHz, no more than 44 kHz, no more than 40 kHz, no more than 36 kHz, no more than 32 kHz, no more than 28 kHz, no more than 24 kHz, or no more than 20 kHz, inclusive of all values and ranges therebetween.

Combinations of the above-referenced ranges for the frequency of operation of the ultrasonicator are also contemplated (e.g., greater than or equal to about 20 kHz to less than or equal to about 60 kHz, greater than or equal to about 25 kHz to less than or equal to about 40 kHz).

In some embodiments, stirring and/or agitating may be conducted with a high shear mixer. In such embodiments, the high shear mixer can be configured to operate at a speed of at least 2000 rpm, at least 3000 rpm, at least 4000 rpm, at least 5000 rpm, at least 6000 rpm, at least 7000 rpm, or at least 8000 rpm, inclusive of all values and ranges therebetween. In such embodiments, the high shear mixer can be configured to operate at a speed of no more than 8000 rpm, no more than 6000 rpm, no more than 5000 rpm, no more than 2500 rpm, no more than 1000 rpm, no more than 500 rpm, inclusive of all values and ranges therebetween.

Combinations of the above-referenced ranges for the speed of the high shear mixer are also contemplated (e.g., greater than or equal to about 2000 rpm to less than or equal to about 4000 rpm, greater than or equal to about 2500 rpm to less than or equal to about 5500 rpm).

In some embodiments, the graphene oxide material and water in the first mixture are present at a weight ratio of greater than about 1 to 1500. In some embodiments, the graphene oxide material and water in the first mixture are present at a weight ratio of greater than about 1 to 1400. In some embodiments, the graphene oxide material and water in the first mixture are present at a weight ratio of greater than about 1 to 1300. In some embodiments, the graphene oxide material and water in the first mixture are present at a weight ratio of greater than about 1 to 1200. In some embodiments, the graphene oxide material and water in the first mixture are present at a weight ratio of greater than about 1 to 1100. In some embodiments, the graphene oxide material and water in the first mixture are present at a weight ratio of greater than about 1 to 1000. In some embodiments, the graphene oxide material and water in the first mixture are present at a weight ratio of greater than about 1 to 900. In some embodiments, the graphene oxide material and water in the first mixture are present at a weight ratio of greater than about 1 to 800. In some embodiments, the graphene oxide material and water in the first mixture are present at a weight ratio of greater than about 1 to 700. In some embodiments, the graphene oxide material and water in the first mixture are present at a weight ratio of greater than about 1 to 600. In some embodiments, the graphene oxide material and water in the first mixture are present at a weight ratio of greater than about 1 to 500. In some embodiments, the graphene oxide material and water in the first mixture are present at a weight ratio of greater than about 1 to 400.

In some embodiments, the first mixture further comprises a phase transfer catalyst, such as tetraoctylammonium halide, benzyltriethylammonium halide, methyltricaprylammonium halide, methyltri butylammoniumhalide, and methyltrioctylammonium halide, hexadecyltributylphosphonium halide, and tetra-n-butylammonium halide.

In some embodiments, the halide in the phase transfer catalyst is chloride, bromide, or iodide. In some embodiments, the halide in the phase transfer catalyst is chloride. In some embodiments, the halide in the phase transfer catalyst is bromide. In some embodiments, the halide in the phase transfer catalyst is iodide.

In some embodiments, the second mixture is heated for a period of time of greater than about 2 hours, greater than about 4 hours, greater than about 6 hours, greater than about 8 hours, greater than about 10 hours, or greater than about 12 hours. In some embodiments, the second mixture is heated for a period of time of less than 18 hours, less than about 20 hours, less than about 22 hours, less than about 24 hours, less than about 30 hours, less than about 36 hours, less than about 42 hours, or less than about 48 hours.

Combinations of the above-referenced ranges for the time period are also contemplated. For example, in some embodiments, the second mixture is heated for a period of time of about 2 hours to about 48 hours. In some embodiments, the second mixture is heated for a period of time of about 4 hours to about 36 hours. In some embodiments, the second mixture is heated for a period of time of about 4 hours to about 24 hours.

In some embodiments, the second mixture is heated at a temperature of higher than about 60° C. In some embodiments, the second mixture is heated at a temperature of higher than about 65° C. In some embodiments, the second mixture is heated at a temperature of higher than about 70° C. In some embodiments, the second mixture is heated at a temperature of higher than about 75° C. In some embodiments, the second mixture is heated at a temperature of lower than about 65° C. In some embodiments, the second mixture is heated at a temperature of lower than about 70° C. In some embodiments, the second mixture is heated at a temperature of lower than about 75° C. In some embodiments, the second mixture is heated at a temperature of lower than about 80° C.

Combinations of the above-referenced ranges for the time period are also contemplated. For example, in some embodiments, in some embodiments, the second mixture is heated at a temperature of about 60° C. to about 65° C. In some embodiments, in some embodiments, the second mixture is heated at a temperature of about 65° C. to about 70° C.

In some embodiments, the second mixture is heated at a temperature of about 63° C. to about 67° C.

In some embodiments, the methods further comprising washing the alkylated graphene oxide obtained from step v) with a solvent prior to dispersion. In some embodiments, the solvent is a chlorinated solvent. In some embodiments, the solvent is chloroform.

In some embodiments, the solvent in step v) is an aromatic solvent. Non-limiting examples of aromatic solvents include benzene, benzonitrile, benzyl alcohol, chlorobenzene, dibenzyl ether, 1,2-dichlorobenzene, 1,2-difluorobenzene, hexafluorobenzene, mesitylene, nitrobenzene, pyridine, tetralin, toluene, 1,2,4-trichlorobenzene, trifluorotoluene, and xylenes.

In some embodiments, the solvent in step v) can include methanol, ethanol, propanol, and/or any suitable aliphatic alcohol (e.g., R-OH), dichloromethane, acetonitrile, dimethyl sulfoxide, acetone, dimethylformamide, dioxane, butanone, carbon tetrachloride, and the like.

In some embodiments, the aromatic solvent is selected from benzene, chlorobenzene, 1,2-dichlorobenzene, 1,2-difluorobenzene, toluene, 1,2,4-trichlorobenzene, trifluorotoluene, and xylenes. In some embodiments, the aromatic solvent is selected from benzene, toluene, and xylenes.

In some embodiments, dispersing the alkylated graphene oxide in a solvent in step v) is achieved by ultrasonication or high shear mixing.

In some embodiments, the C₁-C₅ alkyl halide is a C₂-C₅ alkyl halide. In some embodiments, the C₂-C₅ alkyl halide is a C₂-C₅ alkyl chloride or a C₁-C₅ alkyl bromide.

In another aspect, the present disclosure provides graphene oxide membranes produced by the methods disclosed herein.

### Applications

The alkylated graphene oxide membrane or filtration apparatus disclosed herein can be used for a wide range of nanofiltration or microfiltration applications, including but not limited to, concentration of molecules (e.g., whey, lactose), desalting (e.g., lactose, dye, chemicals, pharmaceuticals), fractionation (e.g., sugars), extraction (e.g., nutraceuticals, plant oils), recovery (e.g., catalyst, solvent), and purification (e.g., pharmaceutical, chemical, fuel). For example, a fluid comprising a plurality of species (e.g., plurality of retentate species) may be placed in contact with a first side of the graphene oxide membrane. The graphene oxide membrane may have interlayer spacing and/or intralayer spacing that are sized to prevent greater than a portion of the species from traversing the membrane through the interlayer spacing and/or intralayer spacing, i.e., flowing from the first side of the graphene oxide membrane and to a second, opposing side of the graphene oxide membrane. In some embodiments, the fluid may include one or more types of species (e.g., a retentate species or a permeate species). In some embodiments, the graphene oxide membrane may have an average interlayer spacing and/or intralayer spacing that is sized to prevent greater than a portion of the retentate species from traversing the graphene oxide membrane, while allowing greater than a portion (e.g., substantially all) of the permeate species to traverse the graphene oxide membrane.

The alkylated graphene oxide membrane or filtration apparatus disclosed herein can be used in reverse osmosis to remove ions, molecules, and larger particles from a fluid, e.g., drinking water.

In some embodiments, the alkylated graphene oxide membrane or filtration apparatus disclosed herein can be used in methods for filtering raw milk, cheese whey, whey protein concentrate, mixtures comprising lactose, and whey protein isolate. The methods can include flowing the raw milk through the alkylated graphene oxide membrane.

The alkylated graphene oxide membrane or filtration apparatus disclosed herein can also be used for the removal of lignin from black liquor. In one aspect, the present disclosure provides methods for processing black liquor, the method comprising flowing black liquor through the filtration apparatus as disclosed herein, wherein the black liquor comprises one or more selected from lignin, sodium sulfate, sodium carbonate, sodium hydrosulfide, sodium thiosulfate, and sodium hydroxide.

Weak black liquor (WBL) from pulp digestion is generally produced at 80° C. to 90° C. Cooling the WBL prior to filtration would be very expensive and energy intensive. Without the need for cooling, the WBL can pass through the alkylated graphene oxide membrane described herein at a high temperature, e.g., 80° C. to 90° C. or 75° C. to 85° C. In some embodiments, WBL can be flowed through the filtration apparatus described herein, wherein the WBL comprises lignin, sodium sulfate, sodium carbonate, sodium hydrosulfide, sodium thiosulfate, and/or sodium hydroxide.

The performance of the membrane for WBL filtration can be assessed by the rejection rate on a total solids basis. In some embodiments, the rejection rate is between about 75% and about 95% on a total solids basis, e.g., between about 75% and about 90%, between about 75% and about 85%, or between 80% and about 95% on a total solids basis.

In some embodiments, the alkylated graphene oxide membrane can reject greater than a portion of the lignin. In some embodiments, the graphene oxide membrane can reject greater than about 50%, greater than about 60%, greater than about 70%, greater than about 80%, greater than about 90%, greater than about 95%, greater than about 96%, greater than about 97%, greater than about 98%, greater than about 99%, or greater than about 99.5% of the lignin.

In some embodiments, the alkylated graphene oxide membrane can reject greater than a portion of the sodium sulfate. In some embodiments, the graphene oxide membrane can reject greater than about 50%, greater than about 60%, greater than about 70%, greater than about 80%, greater than about 90%, greater than about 95%, greater than about 96%, greater than about 97%, greater than about 98%, greater than about 99%, or greater than about 99.5% of the sodium sulfate.

In some embodiments, the alkylated graphene oxide membrane can reject greater than a portion of the sodium carbonate. In some embodiments, the graphene oxide membrane can reject greater than about 50%, greater than about 60%, greater than about 70%, greater than about 80%, greater than about 90%, greater than about 95%, greater than about 96%, greater than about 97%, greater than about 98%, greater than about 99%, or greater than about 99.5% of the sodium carbonate.

In some embodiments, the alkylated graphene oxide membrane can reject greater than a portion of the sodium hydrosulfide. In some embodiments, the graphene oxide membrane can reject greater than about 50%, greater than about 60%, greater than about 70%, greater than about 80%, greater than about 90%, greater than about 95%, greater than about 96%, greater than about 97%, greater than about 98%, greater than about 99%, or greater than about 99.5% of the sodium hydrosulfide.

In some embodiments, the alkylated graphene oxide membrane can reject greater than a portion of the sodium thiosulfate. In some embodiments, the graphene oxide membrane can reject greater than about 50%, greater than about 60%, greater than about 70%, greater than about 80%, greater than about 90%, greater than about 95%, greater than about 96%, greater than about 97%, greater than about 98%, greater than about 99%, or greater than about 99.5% of the sodium thiosulfate.

In some embodiments, the alkylated graphene oxide membrane can reject greater than a portion of the sodium hydroxide. In some embodiments, the graphene oxide membrane can reject greater than about 50%, greater than about 60%, greater than about 70%, greater than about 80%, greater than about 90%, greater than about 95%, greater than about 96%, greater than about 97%, greater than about 98%, greater than about 99%, or greater than about 99.5% of the sodium hydroxide.

The alkylated graphene oxide membrane or filtration apparatus disclosed herein can also be used in: (1) point-of-use water purification for military operation missions and for humanitarian relief to disaster-ridden and impoverished areas; (2) on-site treatment of hydrofracking flowback water; (3) renewable energy production; and (4) desalination of water.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

### Definitions

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “greater than one.” Any ranges cited herein are inclusive.

The terms “substantially”, “approximately,” and “about” used throughout this Specification and the claims generally mean plus or minus 10% of the value stated, e.g., about 100 would include 90 to 110.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of greater than one, but also including more than one, of a number or list of elements, and, optionally, additional unlisted items. Only terms clearly indicated to the contrary, such as “only one of” or “exactly one of” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of” “only one of” or “exactly one of” “Consisting essentially of,” when used in the claims, shall have its ordinary meaning as used in the field of patent law.

As used herein in the specification and in the claims, the phrase “greater than one,” in reference to a list of one or more elements, should be understood to mean greater than one element selected from any one or more of the elements in the list of elements, but not necessarily including greater than one of each and every element specifically listed within the list of elements and not excluding any combinations of elements in the list of elements. This definition also allows that elements may optionally be present other than the elements specifically identified within the list of elements to which the phrase “greater than one” refers, whether related or unrelated to those elements specifically identified. Thus, as a non-limiting example, “greater than one of A and B” (or, equivalently, “greater than one of A or B,” or, equivalently “greater than one of A and/or B”) may refer, in one embodiment, to greater than one, optionally including more than one, A, with no B present (and optionally including elements other than B); in another embodiment, to greater than one, optionally including more than one, B, with no A present (and optionally including elements other than A); in yet another embodiment, to greater than one, optionally including more than one, A, and greater than one, optionally including more than one, B (and optionally including other elements); etc.

As used herein, the term “basic” means pH greater than 7.

As used herein, “wt %” refers to weight percent.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein, the term “graphene oxide sheet” means a single atomic graphene oxide layer or a plurality of atomic graphene oxide layers. Each atomic graphene oxide layer may include out-of-plane chemical moieties attached to one or more carbon atoms on the layer. In some embodiments, the term “graphene oxide sheet” means 1 to about 20 atomic graphene oxide layers, e.g., 1 to about 18, 1 to about 16, 1 to about 14, 1 to about 12, 1 to about 10, 1 to about 8, 1 to about 6, 1 to about 4, or 1 to about 3 atomic graphene oxide layers. In some embodiments, the term “graphene oxide sheet” means 1, 2, or 3 atomic graphene oxide layers.

As used herein, the term “flux” means flow rate. It describes the permeability of a membrane.

As used herein, the term “crosslink” refers to the process of connecting two adjacent graphene oxide sheets through one or more chemical linkers.

As used herein, the term “synthetic weak black liquor” refers to an aqueous composition consisting of 1 wt % Pyrogallol, 0.1 wt % Na₂SO₄, 0.61 wt % NaOH, 0.4 wt % KCl and 97.89 wt % H₂O.

As used herein, the term “molecular weight cutoff” refers to greater than 90% (e.g., greater than 92%, greater than 95%, or greater than 98%) rejection rate for molecules with molecular weights greater than the cutoff value.

As used herein, the term “room temperature” can refer to a temperature of about 15° C., about 16° C., about 17° C., about 18° C., about 19° C., about 20° C., about 21° C., about 22° C., about 23° C., about 24° C., or about 25° C. In some embodiments, the room temperature is about 20° C.

As used herein, the term “substantially the same” refers to a first value that is within 10% of a second value. For example, if A is substantially the same as B, and B is 100, A can have a value ranging from 90 to 110. If A is substantially the same as B, and B is 200, A can have a value ranging from 180 to 220.

As used herein, the term “grayscale mode value” refers to the mode value of an image recorded using the RGB color model, calculated with the aid of an image processing software (e.g., ImageJ) by first converting the image to grayscale, where each pixel is converted to grayscale using the formula: gray=0.299*red+0.587*green+0.114*blue, and then quantifying the mode of the distribution of the intensity of the pixels.

As used herein, the term “conductivity rejection” refers to the percentage of conductive species (e.g., ionic species) being rejected by a filtration membrane. The higher the percentage of conductive species is rejected, the higher the conductivity rejection is.

As used herein, the term “optionally substituted” is understood to mean that a given chemical moiety (e.g., an alkyl group) can (but is not required to) be bonded other substituents (e.g., heteroatoms). For instance, an alkyl group that is optionally substituted can be a fully saturated alkyl chain (i.e., a pure hydrocarbon). Alternatively, the same optionally substituted alkyl group can have substituents different from hydrogen. For instance, it can, at any point along the chain be bounded to a halogen atom, a hydroxyl group, or any other substituent described herein. Thus the term “optionally substituted” means that a given chemical moiety has the potential to contain other functional groups, but does not necessarily have any further functional groups. Suitable substituents used in the optional substitution of the described groups include, without limitation, halogen, oxo, —OH, —CN, —COOH, —CH₂CN, —O—(C₁-C₆) alkyl, (C₁-C₆) alkyl, C₁-C₆ alkoxy, (C₁-C₆) haloalkyl, C₁-C₆ haloalkoxy, —O—(C₂-C₆) alkenyl, —O—(C₂-C₆) alkynyl, (C₂-C₆) alkenyl, (C₂-C₆) alkynyl, —OH, —OP(O)(OH)₂, —OC(O)(C₁-C₆) alkyl, —C(O)(C₁-C₆) alkyl, —OC(O)O(C₁-C₆) alkyl, —NH₂, —NH((C₁-C₆) alkyl), —N((C₁-C₆) alkyl)₂, —NHC(O)(C₁-C₆) alkyl, 613 C(O)NH(C₁-C₆) alkyl, —S(O)₂(C₁-C₆) alkyl, —S(O)NH(C₁-C₆) alkyl, and —S(O)N((C₁-C₆) alkyl)₂. The substituents can themselves be optionally substituted.

As used herein, the term “hydroxy” or “hydroxyl” refers to the group —OH or O⁻.

As used herein, “halo” or “halogen” refers to fluoro, chloro, bromo, and iodo.

The term “carbonyl” includes compounds and moieties which contain a carbon connected with a double bond to an oxygen atom. Examples of moieties containing a carbonyl include, but are not limited to, aldehydes, ketones, carboxylic acids, amides, esters, anhydrides, etc.

The term “carboxyl” refers to —COOH or its C₁-C₆ alkyl ester.

“Acyl” includes moieties that contain the acyl radical (R-C(O)-) or a carbonyl group. “Substituted acyl” includes acyl groups where one or more of the hydrogen atoms are replaced by, for example, alkyl groups, alkynyl groups, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moiety.

The term “alkoxy” or “alkoxyl” includes substituted and unsubstituted alkyl, alkenyl and alkynyl groups covalently linked to an oxygen atom. Examples of alkoxy groups or alkoxyl radicals include, but are not limited to, methoxy, ethoxy, isopropyloxy, propoxy, butoxy and pentoxy groups. Examples of substituted alkoxy groups include halogenated alkoxy groups. The alkoxy groups can be substituted with groups such as alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moieties. Examples of halogen substituted alkoxy groups include, but are not limited to, fluoromethoxy, difluoromethoxy, trifluoromethoxy, chloromethoxy, dichloromethoxy and trichloromethoxy.

The term “ether” or “alkoxy” includes compounds or moieties which contain an oxygen bonded to two carbon atoms or heteroatoms. For example, the term includes “alkoxyalkyl,” which refers to an alkyl, alkenyl, or alkynyl group covalently bonded to an oxygen atom which is covalently bonded to an alkyl group.

The term “ester” includes compounds or moieties which contain a carbon or a heteroatom bound to an oxygen atom which is bonded to the carbon of a carbonyl group. The term “ester” includes alkoxycarboxy groups such as methoxycarbonyl, ethoxycarbonyl, propoxycarbonyl, butoxycarbonyl, pentoxycarbonyl, etc.

The term “thioalkyl” includes compounds or moieties which contain an alkyl group connected with a sulfur atom. The thioalkyl groups can be substituted with groups such as alkyl, alkenyl, alkynyl, halogen, hydroxyl, alkylcarbonyloxy, arylcarbonyloxy, alkoxycarbonyloxy, aryloxycarbonyloxy, carboxylate, carboxyacid, alkylcarbonyl, arylcarbonyl, alkoxycarbonyl, aminocarbonyl, alkylaminocarbonyl, dialkylaminocarbonyl, alkylthiocarbonyl, alkoxyl, amino (including alkylamino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moieties.

The term “thiocarbonyl” or “thiocarboxy” includes compounds and moieties which contain a carbon connected with a double bond to a sulfur atom.

As used herein, “amino” or “amine,” as used herein, refers to a primary (—NH₂), secondary (—NHRₓ), tertiary (—NRₓR_{y}), or quaternary amine (—N⁺RₓR_{y}R_{z}), where Rₓ, R_{y}, and R_{z} are independently an aliphatic, alicyclic, heteroaliphatic, heterocyclic, aryl, or heteroaryl moiety, as defined herein. Examples of amine groups include, but are not limited to, methylamine, dimethylamine, ethylamine, diethylamine, methylethylamine, iso-propylamine, piperidine, trimethylamine, and propylamine. “Alkylamino” includes groups of compounds wherein the nitrogen of —NH₂ is bound to greater than one alkyl group. Examples of alkylamino groups include benzylamino, methylamino, ethylamino, phenethylamino, etc. “Dialkylamino” includes groups wherein the nitrogen of —NH₂ is bound to two alkyl groups. Examples of dialkylamino groups include, but are not limited to, dimethylamino and diethylamino. “Acylamino” and “diarylamino” include groups wherein the nitrogen is bound to greater than one or two aryl groups, respectively. “Aminoacyl” and “aminoaryloxy” refer to aryl and aryloxy substituted with amino. “Alkylarylamino,” “alkylaminoaryl” or “arylaminoalkyl” refers to an amino group which is bound to greater than one alkyl group and greater than one aryl group. “Alkaminoalkyl” refers to an alkyl, alkenyl, or alkynyl group bound to a nitrogen atom which is also bound to an alkyl group. “Acylamino” includes groups wherein nitrogen is bound to an acyl group. Examples of acylamino include, but are not limited to, alkylcarbonylamino, arylcarbonylamino, carbamoyl and ureido groups.

The term “amide” or “aminocarboxy” includes compounds or moieties that contain a nitrogen atom that is bound to the carbon of a carbonyl or a thiocarbonyl group. The term includes “alkaminocarboxy” groups that include alkyl, alkenyl or alkynyl groups bound to an amino group which is bound to the carbon of a carbonyl or thiocarbonyl group. It also includes “arylaminocarboxy” groups that include aryl or heteroaryl moieties bound to an amino group that is bound to the carbon of a carbonyl or thiocarbonyl group. The terms “alkylaminocarboxy”, “alkenylaminocarboxy”, “alkynylaminocarboxy” and “arylaminocarboxy” include moieties wherein alkyl, alkenyl, alkynyl and aryl moieties, respectively, are bound to a nitrogen atom which is in turn bound to the carbon of a carbonyl group. Amides can be substituted with substituents such as straight chain alkyl, branched alkyl, cycloalkyl, aryl, heteroaryl or heterocycle. Substituents on amide groups may be further substituted.

Unless otherwise specifically defined, the term “aryl” refers to cyclic, aromatic hydrocarbon groups that have 1 to 3 aromatic rings, including monocyclic or bicyclic groups such as phenyl, biphenyl or naphthyl. Where containing two aromatic rings (bicyclic, etc.), the aromatic rings of the aryl group may be joined at a single point (e.g., biphenyl), or fused (e.g., naphthyl). The aryl group may be optionally substituted by one or more substituents, e.g., 1 to 5 substituents, at any point of attachment. Exemplary substituents include, but are not limited to, —H, -halogen, —O—(C₁-C₆) alkyl, (C₁-C₆) alkyl, -O-(C₂-C₆) alkenyl, —O—(C₂-C₆) alkynyl, (C₂-C₆) alkenyl, (C₂-C₆) alkynyl, —OH, —OP(O)(OH)₂, —OC(O)(C₁-C₆) alkyl, —C(O)(C₁i-C₆) alkyl, —OC(O)O(C₁-C₆) alkyl, NH₂, NH((C₁-C₆) alkyl), N((C₁-C₆) alkyl)₂, —S(O)₂-(C₁-C₆) alkyl, —S(O)NH(C₁-C₆) alkyl, and —S(O)N((C₁-C₆) alkyl)₂. The substituents can themselves be optionally substituted. Furthermore, when containing two fused rings the aryl groups herein defined may have an unsaturated or partially saturated ring fused with a fully saturated ring. Exemplary ring systems of these aryl groups include, but are not limited to, phenyl, biphenyl, naphthyl, anthracenyl, phenalenyl, phenanthrenyl, indanyl, indenyl, tetrahydronaphthalenyl, tetrahydrobenzoannulenyl, and the like.

Unless otherwise specifically defined, “heteroaryl” means a monocyclic aromatic radical of 5 to 24 ring atoms or a polycyclic aromatic radical, containing one or more ring heteroatoms selected from N, O, or S, the remaining ring atoms being C. Heteroaryl as herein defined also means a bicyclic heteroaromatic group wherein the heteroatom is selected from N, O, or S. The aromatic radical is optionally substituted independently with one or more substituents described herein. Examples include, but are not limited to, furyl, thienyl, pyrrolyl, pyridyl, pyrazolyl, pyrimidinyl, imidazolyl, isoxazolyl, oxazolyl, oxadiazolyl, pyrazinyl, indolyl, thiophen-2-yl, quinolyl, benzopyranyl, isothiazolyl, thiazolyl, thiadiazole, indazole, benzimidazolyl, thieno[3,2-b]thiophene, triazolyl, triazinyl, imidazo[1,2-b]pyrazolyl, furo[2,3-c]pyridinyl, imidazo[1,2-a]pyridinyl, indazolyl, pyrrolo[2,3-c]pyridinyl, pyrrolo[3,2-c]pyridinyl, pyrazolo[3,4-c]pyridinyl, thieno[3,2-c]pyridinyl, thieno[2,3-c]pyridinyl, thieno [2,3-b]pyridinyl, benzothiazolyl, indolyl, indolinyl, indolinonyl, dihydrobenzothiophenyl, dihydrobenzofuranyl, benzofuran, chromanyl, thiochromanyl, tetrahydroquinolinyl, dihydrobenzothiazine, dihydrobenzoxanyl, quinolinyl, isoquinolinyl, 1,6-naphthyridinyl, benzo[de]isoquinolinyl, pyrido[4,3-b][1,6]naphthyridinyl, thieno [2,3-b]pyrazinyl, quinazolinyl, tetrazolo[1,5-a]pyridinyl, [1,2,4]triazolo[4,3-a]pyridinyl, isoindolyl, pyrrolo [2,3-b]pyridinyl, pyrrolo[3,4-b]pyridinyl, pyrrolo[3,2-b]pyridinyl, imidazo [5,4-b]pyridinyl, pyrrolo[1,2-a]pyrimidinyl, tetrahydro pyrrolo[1,2-a]pyrimidinyl, 3,4-dihydro-2H-1λ²-pyrrolo[2,1-b]pyrimidine, dibenzo [b,d]thiophene, pyridin-2-one, furo [3,2-c] pyridinyl, furo[2,3-c]pyridinyl, 1H-pyrido[3,4-b][1,4] thiazinyl, benzooxazolyl, benzoisoxazolyl, furo[2,3-b]pyridinyl, benzothiophenyl, 1,5-naphthyridinyl, furo[3,2-b]pyridine, [1,2,4]triazolo[1,5-a]pyridinyl, benzo [1,2,3]triazolyl, imidazo[1,2-a]pyrimidinyl, [1,2,4]triazolo [4,3-b] pyridazinyl, benzo [c][1,2,5]thiadiazolyl, benzo[c][1,2,5] oxadiazole, 1,3-dihydro-2H-benzo[d]imidazol-2-one, 3,4-dihydro-2H-pyrazolo[1,5-b][1,2] oxazinyl, 4,5,6,7-tetrahydropyrazolo[1,5-a] pyridinyl, thiazolo[5,4-d]thiazolyl, imidazo[2,1-b][1,3,4]thiadiazolyl, thieno[2,3-b]pyrrolyl, 3H-indolyl, and derivatives thereof. Furthermore, when containing two fused rings the aryl groups herein defined may have an unsaturated or partially saturated ring fused with a fully saturated ring. Exemplary ring systems of these heteroaryl groups include indolinyl, indolinonyl, dihydrobenzothiophenyl, dihydrobenzofuran, chromanyl, thiochromanyl, tetrahydroquinolinyl, dihydrobenzothiazine, 3,4-dihydro-1H-isoquinolinyl, 2,3-dihydrobenzofuran, indolinyl, indolyl, and dihydrobenzoxanyl.

Furthermore, the terms “aryl” and “heteroaryl” include multicyclic aryl and heteroaryl groups, e.g., tricyclic, bicyclic, e.g., naphthalene, benzoxazole, benzodioxazole, benzothiazole, benzoimidazole, benzothiophene, quinoline, isoquinoline, naphthrydine, indole, benzofuran, purine, benzofuran, deazapurine, indolizine.

“cycloalkyl” refers to a saturated or partially saturated ring structure having about 3 to about 8 ring members that has only carbon atoms as ring atoms and can include divalent radicals. Examples of cycloalkyl groups include but are not limited to, cyclopropyl, cyclobutyl, cyclopentyl, cyclohexyl, cyclohexene, cyclopentenyl, cyclohexenyl.

“Heterocycloalkyl” refers to a saturated or partially unsaturated 3-8 membered monocyclic, 7-12 membered bicyclic (fused, bridged, or spiro rings), or 11-14 membered tricyclic ring system (fused, bridged, or spiro rings) having one or more heteroatoms (such as O, N, S, P, or Se), e.g., 1 or 1-2 or 1-3 or 1-4 or 1-5 or 1-6 heteroatoms, or e.g. 1, 2, 3, 4, 5, or 6 heteroatoms, independently selected from the group consisting of nitrogen, oxygen and sulfur, unless specified otherwise. Examples of heterocycloalkyl groups include, but are not limited to, piperidinyl, piperazinyl, pyrrolidinyl, dioxanyl, tetrahydrofuranyl, isoindolinyl, indolinyl, imidazolidinyl, pyrazolidinyl, oxazolidinyl, isoxazolidinyl, triazolidinyl, oxiranyl, azetidinyl, oxetanyl, thietanyl, 1,2,3,6-tetrahydropyridinyl, tetrahydropyranyl, dihydropyranyl, pyranyl, morpholinyl, tetrahydrothiopyranyl, 1,4-diazepanyl, 1,4-oxazepanyl, 2-oxa-5-azabicyclo[2.2.1]heptanyl, 2,5-diazabicyclo[2.2.1]heptanyl, 2-oxa-6-azaspiro[3.3]heptanyl, 2,6-diazaspiro[3.3]heptanyl, 1,4-dioxa-8-azaspiro [4. 5] decanyl, 1,4-dioxaspiro [4. 5] decanyl, 1-oxaspiro[4.5]decanyl, 1-azaspiro[4.5]decanyl, 3′H-spiro[cyclohexane-1,1′-isobenzofuran]-yl, 7′H-spiro[cyclohexane-1,5′-furo[3,4-b]pyridin]-yl, 3′H-spiro [cyclohexane-1,1′-furo[3,4-c]pyridin]-yl, 3-azabicyclo[3.1.0]hexanyl, 3-azabicyclo[3.1.0]hexan-3-yl, 1,4,5,6-tetrahydropyrrolo[3,4-c]pyrazolyl, 3,4,5,6,7,8-hexahydropyrido[4,3-d]pyrimidinyl, 4,5,6,7-tetrahydro-1H-pyrazolo[3,4-c]pyridinyl, 5,6,7,8-tetrahydropyrido[4,3-d]pyrimidinyl, 2-azaspiro[3.3]heptanyl, 2-methyl-2-azaspiro[3.3]heptanyl, 2-azaspiro[3.5]nonanyl, 2-methyl-2-azaspiro[3.5]nonanyl, 2-azaspiro [4.5]decanyl, 2-methyl-2-azaspiro[4.5]decanyl, 2-oxa-azaspiro[3.4]octanyl, 2-oxa-azaspiro[3.4]octan-6-yl, and the like. In the case of multicyclic heterocycloalkyl, only one of the rings in the heterocycloalkyl needs to be non-aromatic (e.g., 4,5,6,7-tetrahydrobenzo[c]isoxazolyl).

“Alkyl” refers to a straight or branched chain saturated hydrocarbon. C₁-C₆ alkyl groups contain 1 to 6 carbon atoms. Examples of a C₁-C₆ alkyl group include, but are not limited to, methyl, ethyl, propyl, butyl, pentyl, isopropyl, isobutyl, sec-butyl and tert-butyl, isopentyl and neopentyl.

An optionally substituted alkyl refers to unsubstituted alkyl or alkyl having designated substituents replacing one or more hydrogen atoms on one or more carbons of the hydrocarbon backbone. Such substituents can include, for example, alkyl, alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moiety.

The term “hydroxyalkyl” means an alkyl group as defined above, where the alkyl group is substituted with one or more OH groups. Examples of hydroxyalkyl groups include HO—CH₂—, HO—CH₂—CH2- and CH₃—CH(OH)-.

As used herein, “alkylene linker” is intended to include C₁, C₂, C₃, C₄, C₅, C₆, C₇, C₈, C₉, or C₁₀ straight chain (linear) saturated divalent aliphatic hydrocarbon groups and C₂, C₃, C₄, C₅ or C₆, C₇, C₈, C₉, or C₁₀ branched saturated aliphatic hydrocarbon groups. For example, C₁-C₆ alkylene linker is intended to include C₁, C₂, C₃, C₄, C₅ and C₆ alkylene linker groups. Examples of alkylene linker include, moieties having from one to six carbon atoms, such as, but not limited to, methyl (—CH₂-), ethyl (—CH₂CH₂-), n-propyl (—CH₂CH₂CH₂-), i-propyl (—CHCH₃CH₂-), n-butyl (—CH₂CH₂CH₂CH₂-), s-butyl (—CHCH₃CH₂CH₂-), i-butyl (—C(CH₃)₂CH₂-), n-pentyl (—CH₂CH₂CH₂CH₂CH₂-), s-pentyl (—CHCH₃CH₂CH₂CH₂-) or n-hexyl (—CH₂CH₂CH₂CH₂CH₂CH₂-).

As used herein, “alkenyl” includes unsaturated aliphatic groups analogous in length and possible substitution to the alkyls described above, but that contain greater than one double bond. For example, the term “alkenyl” includes straight chain alkenyl groups (e.g., ethenyl, propenyl, butenyl, pentenyl, hexenyl, heptenyl, octenyl, nonenyl, decenyl), and branched alkenyl groups.

An optionally substituted alkenyl refers to unsubstituted alkenyl or alkenyl having designated substituents replacing one or more hydrogen atoms on one or more hydrocarbon backbone carbon atoms. Such substituents can include, for example, alkyl, alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, heterocyclyl, alkylaryl, or an aromatic or heteroaromatic moiety.

“Alkynyl” includes unsaturated aliphatic groups analogous in length and possible substitution to the alkyls described above, but which contain greater than one triple bond. For example, “alkynyl” includes straight chain alkynyl groups (e.g., ethynyl, propynyl, butynyl, pentynyl, hexynyl, heptynyl, octynyl, nonynyl, decynyl), and branched alkynyl groups. In certain embodiments, a straight chain or branched alkynyl group has six or fewer carbon atoms in its backbone (e.g., C₂-C₆ for straight chain, C₃-C₆ for branched chain). The term “C₂-C₆” includes alkynyl groups containing two to six carbon atoms. The term “C₃-C₆” includes alkynyl groups containing three to six carbon atoms.

An optionally substituted alkynyl refers to unsubstituted alkynyl or alkynyl having designated substituents replacing one or more hydrogen atoms on one or more hydrocarbon backbone carbon atoms. Such substituents can include, for example, alkyl, alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moiety.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

### EXAMPLES

### Example 1

### Synthesis and Characterization of Alkylated Graphene Oxide (Propyl-GO) and Alkylated Graphene Oxide Membrane

A graphene oxide dispersion (102.5 mL, 0.98 mg/mL) and sodium hydroxide (72 mg, 1.8 mmol) were added to a beaker and placed in a high shear mixer (Silverson L5M-A) with a general-purpose disintegrating head for 1 hour at 3000 rpm for exfoliating. Following exfoliation, tetraoctylammonium bromide (100 mg, 0.18 mmol) and 1-bromopropane (6.75 g, 55.0 mmol) were added, and the resulting mixture was stirred for 6 hours at 65° C. Water was removed from the mixture by vacuum filtration. The mixture was subsequently washed with methanol 3 times with 50 mL of solvent. Following washing, the alkylated material is dried for 12-16 hours at 65° C., and then redispersed in toluene (8 mg/mL) using the high shear mixing (Silverson, L5M-A) with general-purpose disintegrating head for 30 minutes at 5000 rpm, and then changing the head to the emulsor screen for 2 hours at.

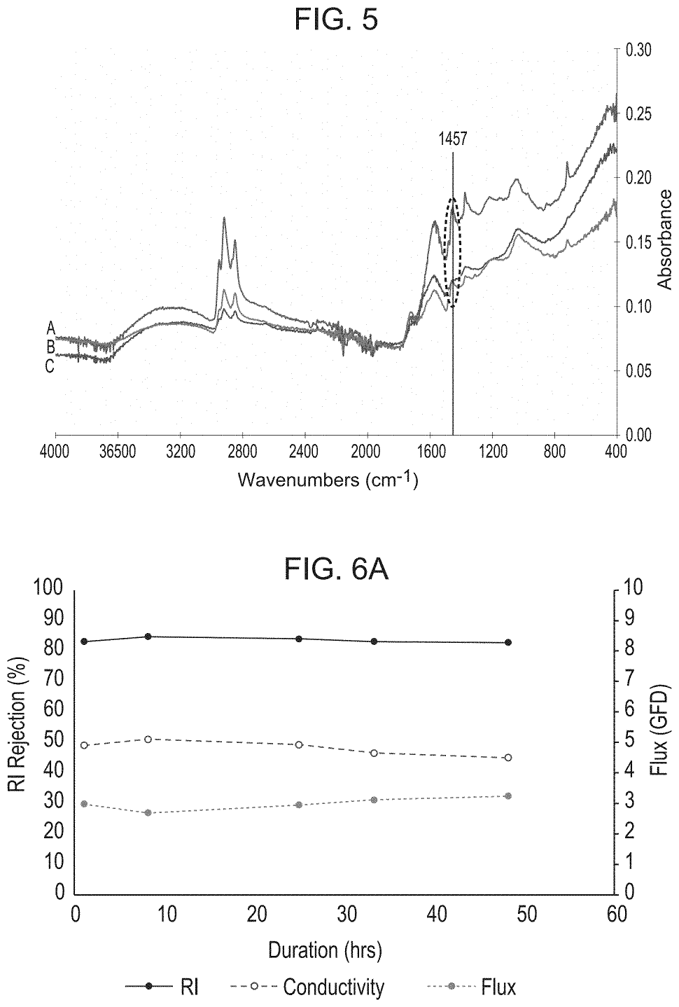

FIG. 5 shows the FTIR spectra for the synthesize alkylated graphene oxide. Reaction temperature is a parameter during the synthesis. Spectra A, B, and C were recorded at room temperature after the synthesis reaction at i) at 65° C. for 6 hours (Spectrum A); ii) at 60° C. for 6 hours (Spectrum B); and iii) at 60° C. for 24 hours (Spectrum C). For reactions at a temperature of 60° C., the FTIR spectra of this material shows that the peak at 1457cm⁻¹ is absent even though the reaction time is prolonged to 24 hours. For the reaction at 65° C. for 6 hours, the FTIR spectrum shows the bands at 2924 and 2852 cm⁻¹ and the peak at 1457 cm^{-1,} suggesting the presence of alkyl groups on the GO surface.

During the Alkyl-GO synthesis, the amount of water employed during the exfoliation step is also important. Different concentrations during the exfoliation step, 1:1800, 1:900, 1:250 (GO:Water) were studied. It was found that at 1:250 the GO aggregated, regardless of the extent of stirring with the high shear mixer. The exfoliation at a ratio of 1:900 produced a stable material and filtration data, which has similar performance to control (1:1800). A more concentrated exfoliation step makes the process much easier to scale. FIG. 2 shows the filtration performance (e.g., rejection rate) at different exfoliation concentrations.

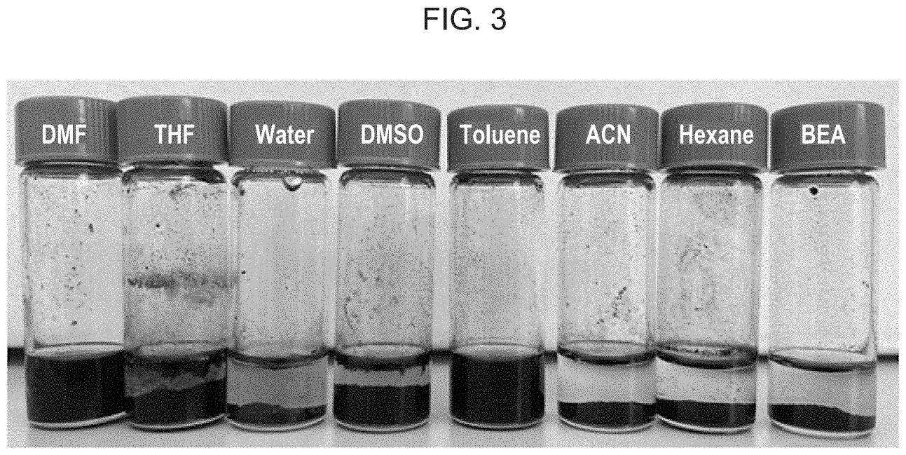

Various solvents were tested to explore the stability of Propyl-GO (FIG. 3). Propyl-GO was added to 4 mL scintillation vials (8 mg/mL). The vials were sonicated at 40 KHz for 2 hours and left undisturbed for 48 hours at room temperature.

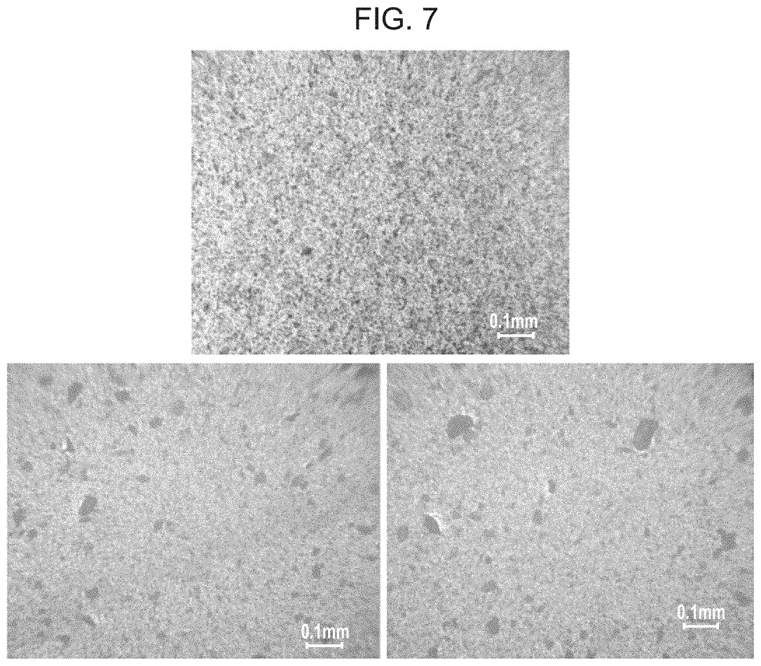

Membrane surface morphology was also studied. As shown in FIG. 7, hexylated graphene oxide (Hexyl-GO) membranes showed bigger aggregates and the solubilization step was more difficult. Based on these observations, 1-bromopropane (Propyl-GO) was the alkyl-halide chosen.

### Example 2

### Adhesion Property

Adhesion property of the alkyl-GO samples were shown to be greatly improved compared to PG1 (control) as well as PG1 with extended reaction heating time (RAD-1). PG1 is proprionamide functionalized graphene oxide. RAD-1 is proprionamide functionalized graphene oxide with extended heating time of 24 hours (PG1 has 3 hours of heating time). The synthesis of PG1 and RAD-1 is disclosed in International Patent Application Number WO2020/232398, entitled “Durable Graphene Oxide Membranes,” filed May 15, 2020, the contents of which are incorporated herein by reference. To measure adhesion, a tape test adapted from the ASTM D3359 test with the following procedure:
1. Cut a piece of tape (Adhesive ASTM D3359 Cross Hatch Adhesion Test Tape) and fold a corner so it is easy for removal.
2. Place the piece of tape in the coating area (away from edges), make sure that the tape is in contact with the surface. Avoid creating any air gaps.
3. Wait 90 seconds and remove the tape in one quick motion.

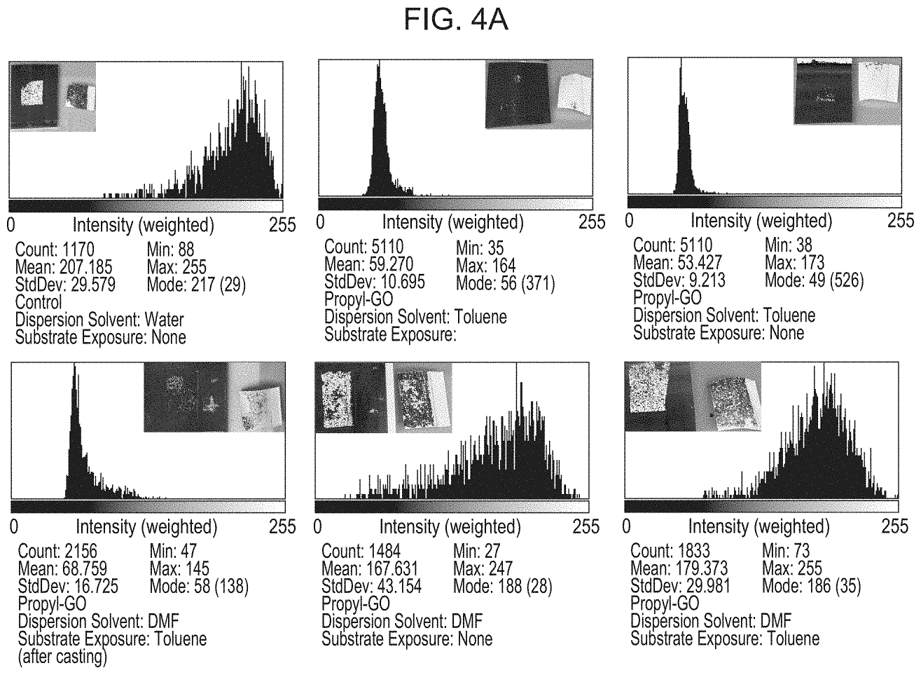

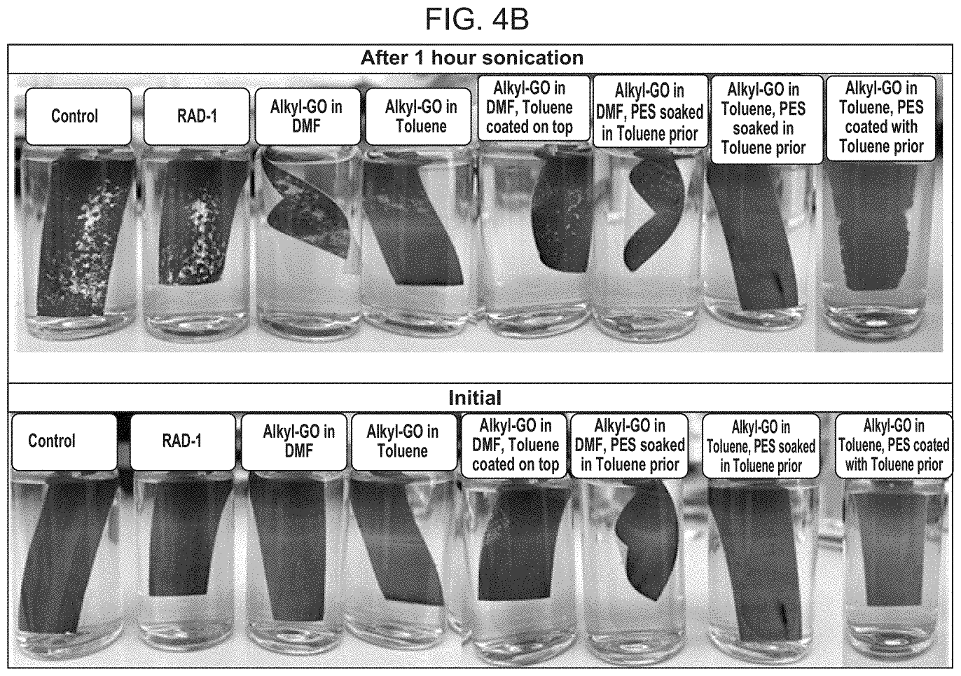

To quantify the results of the modified ASTM D3359 tape test, ImageJ was used to create histograms of the gray values. The results are shown in FIG. 4A. A mean intensity <70 is considered good adhesion, and a mean intensity >160 in considered poor adhesion.

To better understand adhesion in environments that better mimic the end use, strips of different membranes were cut, placed in 25 mL scintillation vials, and submerged in pH 13 weak black liquor permeate. The vials were sonicated at 40 kHz for 1 hour, and the results are shown in FIG. 4B. From left to right, row 1: control, RAD-1, alky-GO in DMF, alkyl-GO in toluene, alkyl-GO in DMF with toluene coated on top, alkyl-GO in DMF with PES soaked in toluene prior, alkyl-GO in toluene with PES soaked in toluene prior, alkyl-GO in toluene with PES that had been coated with toluene prior; row 2: the same samples shown in row 1 after one hour of sonication.

### Example 3

### Filtration

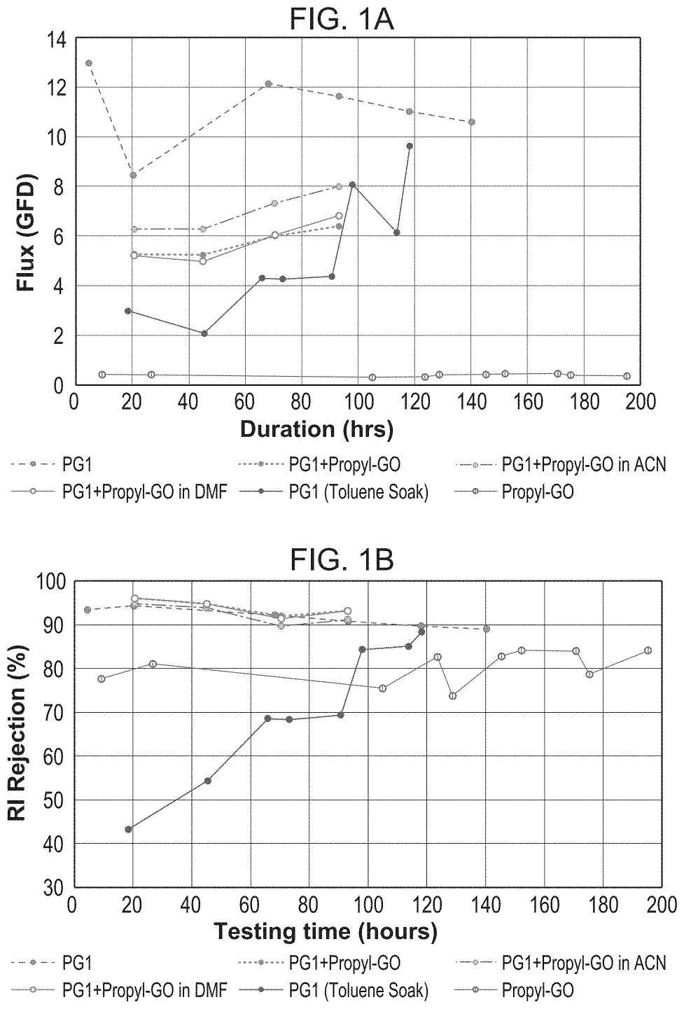

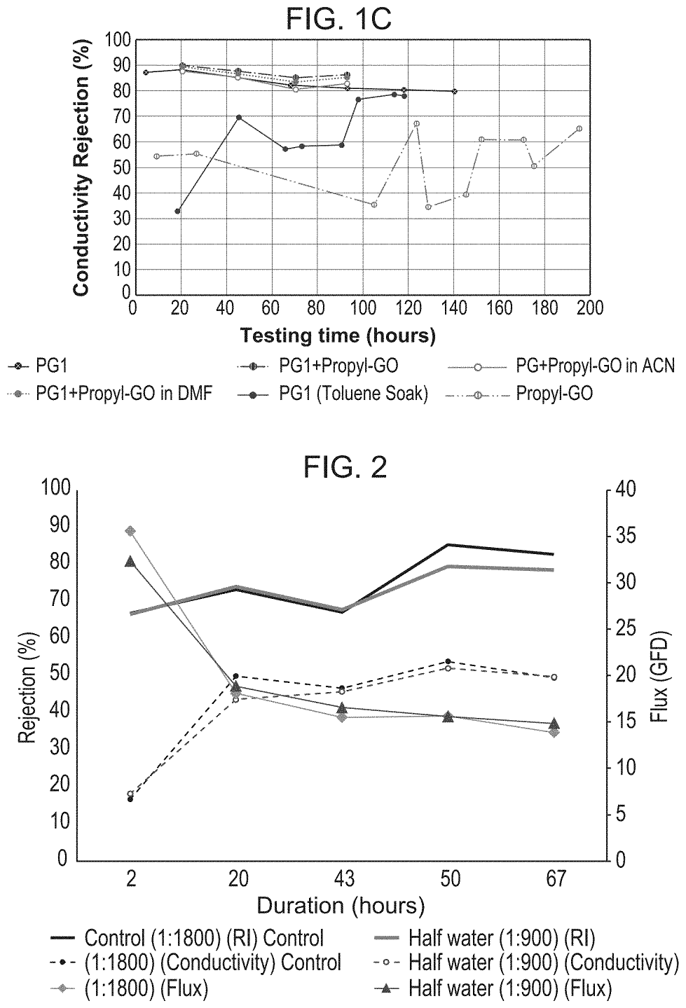

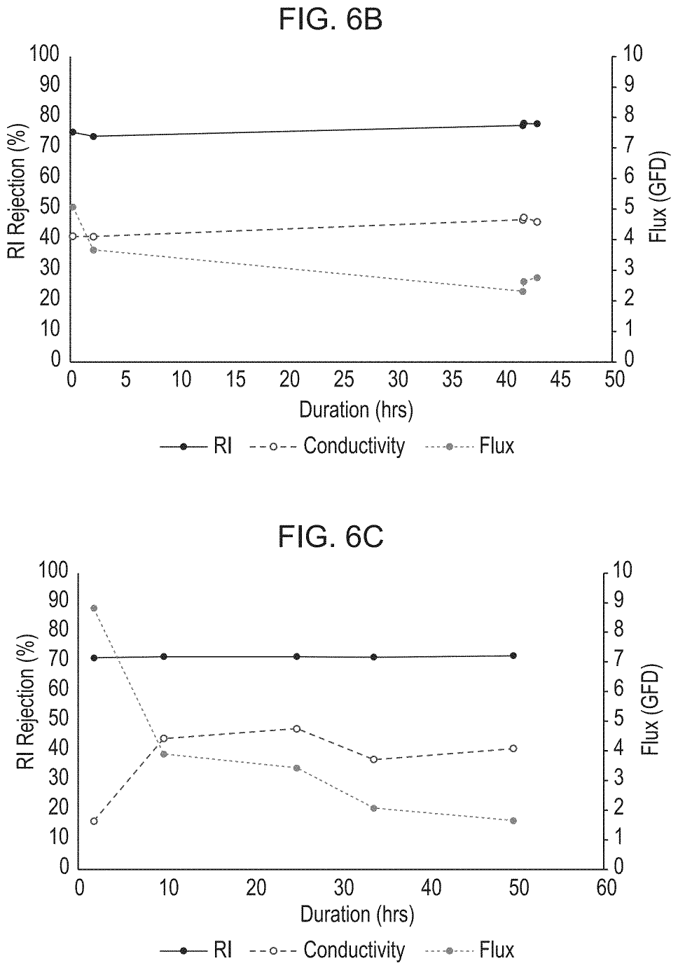

FIGS. 1A-1C show the filtration data for sWBL. Due to the limited solubility of Propyl-GO in water (the solvent used for PG1), Propyl-GO was incorporated as a 1:1 (v/v) mixture with PG1 in water (PG1+Propyl-GO trace), acetonitrile (PG1+Propyl-GO in ACN trace), and dimethylformamide (PG1+Propyl-GO in DMF). To understand the contributions of the GO modification versus solvent on filtration performance, the polyethersulfone substrate was initially soaked in toluene and then PG1 was cast on top (PG1 (Toluene Soak) trace). The Propyl-GO (Propyl-GO trace) is produced by casting a toluene dispersion of alkyl-functionalized graphene oxide. To better understand adhesion in environments that better mimic the end use, Weak black liquor filtration data for Propyl-GO is reported for a variety of different liquors in FIG. 6A, FIG. 6B, and FIG. 6C. The data in FIG. 6A is for a softwood kraft pulp sourced from a mill in Georgia, and the test was run at 800 psig and 75° C. The data in FIG. 6B is for a hardwood sourced from a mill in Wisconsin, and the test was run at 1000 psig and 75° C. The data in FIG. 6C is for a eucalyptus kraft pulp, and the test was run at 800 psig and 75° C.

Filtration with multiple passes was also studied. Briefly, the permeate collected during the “1^{st} pass” is used as the process feed in the “2^{nd} pass” and the permeate from the “2^{nd} pass” is used as the process feed for the “3^{rd} pass”. In between passes a cleaning step is conducted at 150 psig and 40° C. for 1 hour.

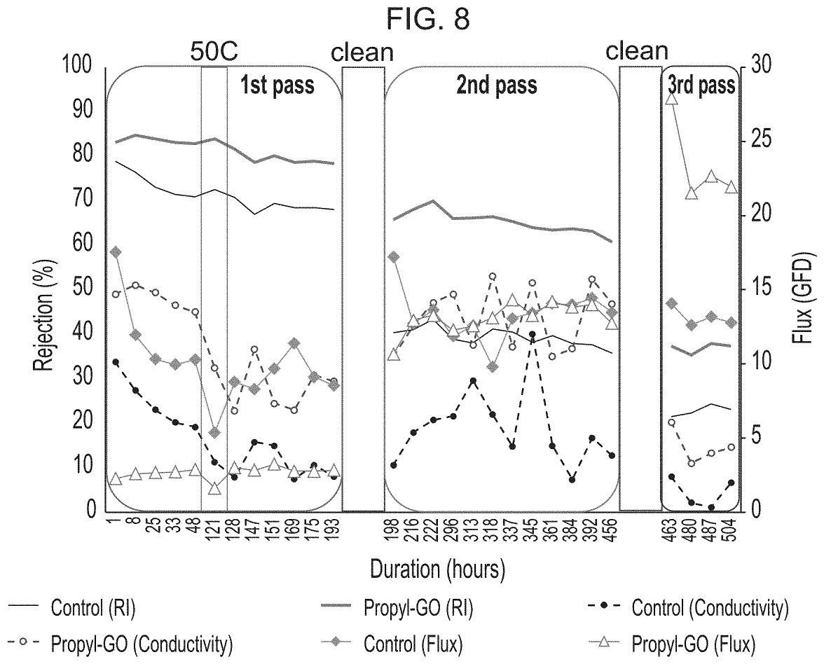

FIG. 8 is a graph showing the filtration data for Propyl-GO with softwood kraft pulp sourced from a mill in Georgia. The test was conducted at 800 psig and 75° C., and demonstrates the filtration performance over three passes.

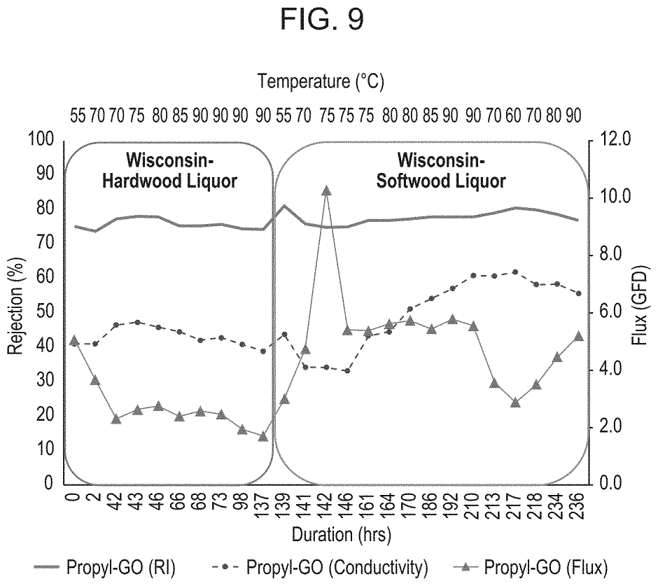

The filtration data for Propyl-GO with both hardwood and softwood kraft pulp sourced from a mill in Wisconsin are shown in FIG. 9. The test was conducted at 1000 psig with a 1 hour clean between switching feeds.

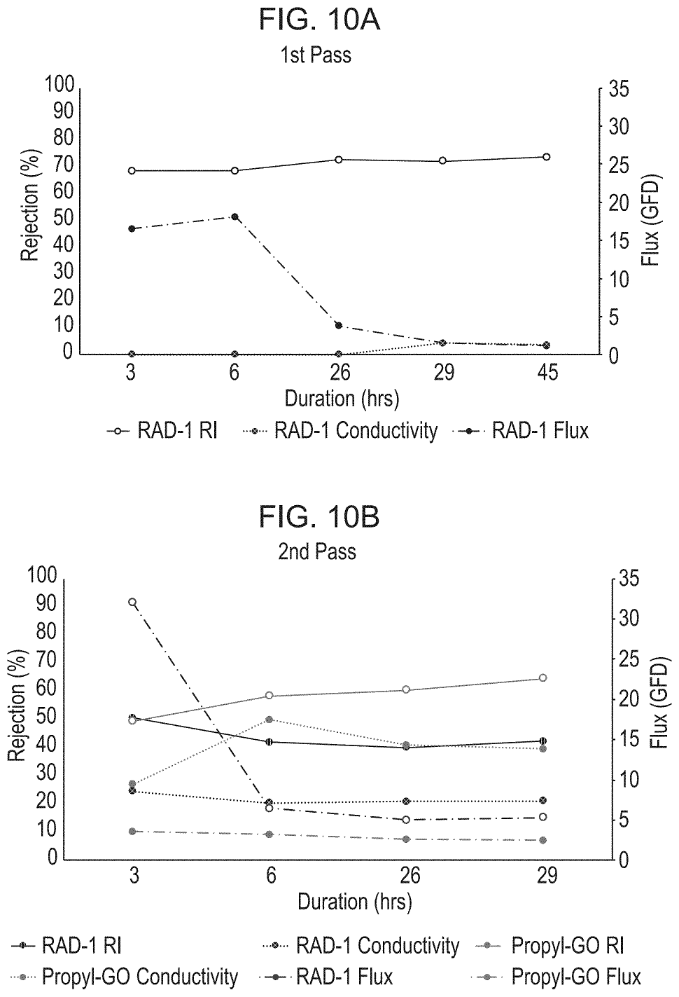

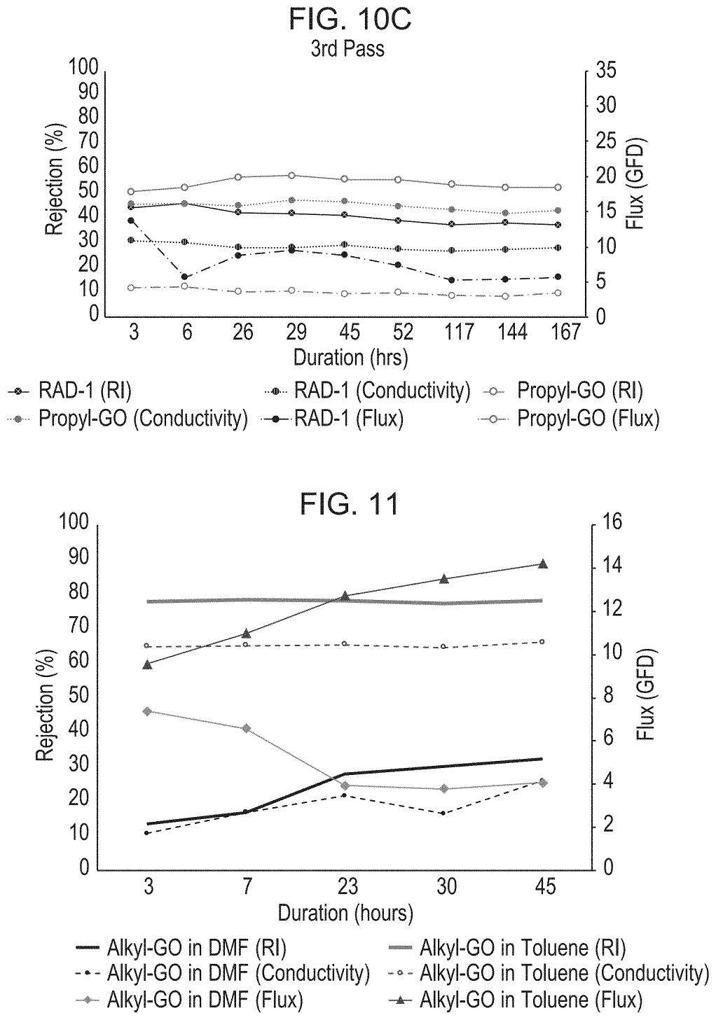

FIGS. 10A-10C are a set of graphs showing the 1^{st} to 3^{rd} passes filtration data for RAD-1 (a propionamide functionalized graphene oxide that has been heated for 24 hours).

FIG. 11 is a graph showing the crossflow filtration data with the 1^{st} pass permeate collected from a softwood kraft pulp sourced from a mill in Georgia. The test was conducted at 800 psi and 75° C. Solvent studies showed that DMF and toluene are good candidates for the material solubilization. Filtration data showed that DMF has worse filtration performance than toluene.

### Example 4

### Large Scale Synthesis of Alkylated Graphene Oxide (Propyl-GO)

A graphene oxide dispersion (60 L, 4mg/mL), water (182 L), and sodium hydroxide (180 g, 4.5 mol) were mixed in a 100-gal reactor. The resulting mixture was exfoliated using an IKA Process Pilot 2000/4 mixer outfitted with a 6F/2G/2G rotor. Following exfoliation, tetraoctylammonium bromide (240 g, 0.44 mol) and 1-bromopropane (12 g, 98.0 mmol) were added, and the resulting mixture was stirred for 6 hours at 65° C. Water was removed from the mixture by vacuum filtration, and the alkylated material was subsequently washed with methanol. Following washing with methanol, the alkylated material is dried for 12-16 hours at 65° C. in a vacuum oven. The resulting material was then redispersed in toluene (8 mg/mL) using the IKA Process Pilot 2000/4 (outfitted with a 6F/2G/2G rotor stack) mixer, in a loop configuration operating at 60 Hz.

1. A filtration apparatus, comprising:
a support substrate; and
an alkylated graphene oxide membrane disposed on the support substrate, the alkylated graphene oxide membrane comprising a plurality of graphene oxide layers, each graphene oxide layer including at least one graphene oxide sheet covalently coupled to a chemical spacer, the chemical spacer being of Formula I: 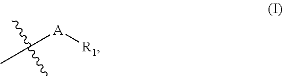
wherein:
A is O, NH, or S;
R₁ is optionally substituted C₁-C₅ alkyl; and [symbol]
indicates a point of connection to a carbon atom on the alkylated graphene oxide sheet.

2. The filtration apparatus of claim 1, wherein A is O.

3. The filtration apparatus of claim 1, wherein R₁ is optionally substituted C₂-C₅ alkyl.

4. The filtration apparatus of claim 1, wherein R₁ is selected from —CH₂CH₃, —(CH₂)₂CH₃, —CH(CH₃)₂, —(CH₂)₃CH₃, —CH(CH₃)₂CH₂CH₃, —CH₂CH(CH₃)₂, or —C(CH₃)₃, —(CH₂)₄CH₃, —C(CH₃)₂CH₂CH₃, —CH₂C(CH₃)₃, —(CH₂)₂CH(CH₃)₂, —CH(CH₃)(CH₂)₂CH₃, —CH(CH₂CH₃)₂, —CH(CH₃)CH(CH₃)₂, and —CH₂CH(CH₃)CH₂CH₃.

5. The filtration apparatus of claim 1, wherein R₁ is —(CH₂)₂CH₃.

6. The filtration apparatus of claim 1, wherein the filtration apparatus has a conductivity rejection rate of at least 50% for synthetic weak black liquor.

7. The filtration apparatus of claim 1, wherein the filtration apparatus is further characterized by a flux of greater than 5.0E-04 gallons per square foot per day per psi (GFD/psi) for synthetic weak black liquor.

8. The filtration apparatus of claim 1, wherein each of the graphene oxide sheets is not covalently crosslinked to the adjacent graphene oxide sheet.

9. The filtration apparatus of claim 1, wherein the support substrate comprises one or more material selected from polypropylene (PP), polystyrene, polyethylene, polyethylene oxide, polyethersulfone (PES), polytetrafluoroethylene (PTFE), polyvinylidene fluoride, polymethylmethacrylate, polydimethylsiloxane, polyester, polyolefin, cellulose, cellulose acetate, cellulose nitrate, polyacrylonitrile, glass fiber, quartz, alumina, silver, polycarbonate, nylon, Kevlar or other aramid, and polyether ether ketone.

10. The filtration apparatus of claim 1, wherein the graphene oxide membrane has a thickness of about 25 nm to about 5 μm.

11. The filtration apparatus of claim 1, wherein the graphene oxide membrane has about 100 to about 600 graphene oxide layers.

12. The filtration apparatus of any one of claim 1, wherein the conductivity rejection rate is measured at room temperature.

13. The filtration apparatus of claim 1, wherein the filtration apparatus has a conductivity rejection of at least 60% for synthetic weak black liquor, or at least 40% for weak black liquor.

14. A method of preparing a graphene oxide membrane, comprising:
i) agitating a first mixture of a graphene oxide material and a base in water, thereby exfoliating graphene oxide layers from the graphene oxide material;
ii) adding a C₁-C₅ alkyl halide to the first mixture to form a second mixture;
iii) heating the second mixture for a period of time at greater than 60° C., thereby forming an alkylated graphene oxide;
iv) removing water from the second mixture to obtain the alkylated graphene oxide;
v) dispersing the alkylated graphene oxide in a solvent, thereby forming an alkylated graphene oxide dispersion; and
vi) casting the alkylated graphene oxide dispersion onto a support substrate, thereby forming the graphene oxide membrane.

15. The method of claim 14, wherein the base comprises NaOH, KOH, or a combination thereof.

16. The method of claim 14, wherein the graphene oxide material to water in the first mixture are present at a weight ratio of greater than about 1 to 900.

17. The method of claim 14, wherein the first mixture further comprises a phase transfer catalyst.

18. The method of claim 17, wherein the phase transfer catalyst is selected from tetraoctylammonium halide, benzyltriethylammonium halide, methyltricaprylammonium methyltributylammonium halide, and methyltrioctylammonium halide, hexadecyltributylphosphoniurn halide, and tetra-n-butylammonium halide.

19. The method of claim 14, wherein the second mixture is heated for a period of time of about 4 hours to about 24 hours.

20. The method of claim 14, wherein the second mixture is heated at a temperature of about 63° C. to about 67° C.

21. The method of claim 14, further comprising washing the alkylated graphene oxide obtained from step iv) with chloroform or methanol prior to dispersion.

22. The method of claim 14, wherein the solvent in step v) is an aromatic solvent.

23. The method of claim 22, wherein the aromatic solvent is selected from benzene, benzonitrile, benzyl alcohol, chlorobenzene, dibenzyl ether, 1,2-dichlorobenzene, 1,2-difluorobenzene, hexafluorobenzene, mesitylene, nitrobenzene, pyridine, tetralin, toluene, 1,2,4-trichlorobenzene, trifluorotoluene, and xylenes.

24. The method of claim 22, wherein the aromatic solvent is selected from benzene, chlorobenzene, 1,2-dichlorobenzene, 1,2-difluorobenzene, toluene, 1,2,4-trichlorobenzene, trifluorotoluene, and xylenes.

25. The method of claim 22, wherein the aromatic solvent is selected from benzene, chlorobenzene, toluene, and xylenes.

26. The method of claim 14, wherein dispersing the alkylated graphene oxide in a solvent in step v) comprises ultrasonication or high shear mixing.

27. The method of claim 14, wherein the C₁-C₅ alkyl halide is C₂-C₅ alkyl halide.

28. The method of claim 14, wherein the C₂-C₅ alkyl halide is C₂-C₅ alkyl chloride, C₂-C₅ alkyl-iodide, or C₁-C₅ alkyl bromide.

29-30. (canceled)
